(19) United States
(12) Patent Application Publication
(10) Pub. No.: US 2012/0212661 A1
(43) Pub. Date: Aug. 23, 2012

(54) IMAGING APPARATUS, FOCUS CONTROL METHOD, AND PROGRAM

(75) Inventors: Hiroaki YAMAGUCHI, Kanagawa (JP); Toru Shiono, Tokyo (JP); Shinichi Fujii, Kanagawa (JP); Junko Nagahata, Tokyo (JP)

(73) Assignee: Sony Corporation, Tokyo (JP)

(21) Appl. No.: 13/359,929

(22) Filed: Jan. 27, 2012

(30) Foreign Application Priority Data
Feb. 22, 2011 (JP) 2011-035888

(51) Int. Cl. G03B 13/32

(52) U.S. Cl. 348/346; 348/345; 348/E05.045

(57) ABSTRACT

An imaging apparatus includes: a display unit that displays an image photographed by an imaging element; and a focus control unit that performs focus control of inputting information regarding a selected image region of the image displayed on the display unit and setting a subject contained in the selected image region as a focusing target. The focus control unit performs the focus control by determining a driving speed of a focus lens based on information regarding an operation of a user and moving the focus lens at the determined driving speed of the focus lens.

### BACKGROUND

The present disclosure relates to an imaging apparatus, a focus control method, and a program, and more particularly, to an imaging apparatus, a focus control method, and a program that performs advanced focus control on a subject.

In a movie or drama scene, users sometimes view a meaningfully impressive image by moving a focus point and focusing a blurred close person or object so that the close person or object is clearly viewed from a state where a distant person or object has been focused and the close person or object has been blurred.

Such an image can be captured by shallowly setting a depth of field, rotating a focus ring by a manual focus, and driving a focus lens. However, a skilled focusing technique is necessary to comprehend the focus position of the focus lens in accordance with the distance of a subject desired to be focused and smoothly rotate the focus ring up to the focus position while taking an arbitrary time. Moreover, it is difficult for users to capture the image by a manual operation.

Japanese Unexamined Patent Application Publication No. 2010-113291 discloses a technique regarding auto-focus (AF) performed by contrast measurement. The focus control performed based on the contrast measurement is a method of determining the level of the contrast of imaging data acquired via a lens and determining a focus position.

That is, the focus control is performed using information regarding the magnitude of the contrast of an image acquired by a video camera or still camera. For example, a specific area of the captured image is set as a signal acquisition area (space frequency extraction area) for the focus control. This area is called a range-finding frame (detection frame). The focus control is a method of determining that focus is achieved when the contrast of the specific area is higher, whereas determining that the focus is not achieved when the contrast of the specific area is low, and then driving and adjusting the lens at the position where the contrast is higher.

Specifically, for example, a method is applied in which a high-frequency component of the specific area is extracted, integral data of the extracted high-frequency component is generated, and the level of the contrast is determined based on the generated integral data of the high-frequency component. That is, an AF evaluation value indicating the strength of the contrast of each image is obtained by acquiring a plurality of images while moving the focus lens to a plurality of positions and performing filter processing on the luminance signal of each image by a high-pass filter. At this time, when a focused subject is present at a certain focus position, the AF evaluation value for the position of the focus lens is plotted in a curve shown in FIG. 1. A peak position P1 of the curve, that is, the position where the contrast value of the image is the maximum is a focus position. This method is widely used in digital cameras, since a focusing process can be performed based only on information regarding an image captured by an imager which is an imaging element of the digital camera, and thus any range finding optical system is not necessary except for an imaging optical system.

Since the contrast is detected using the image signal read from the imaging element, all points on the imaging element can be focused. However, as shown in FIG. 1, it is necessary to detect the contrast also at focusing positions 12 and 13 before and after the optimum focusing point 11. Accordingly, since it takes some time, a subject may be blurred at the imaging time during the time until the shooting.

As well as the above-described contrast detecting method, a phase difference detecting method is known as an auto-focus control process. In the phase difference detecting method, a light flux passing through an exit pupil of a photographing lens is divided into two light fluxes and the divided two light fluxes are received by a pair of focus detecting sensors (phase difference detecting pixels). The focus lens is adjusted based on the deviation amounts of signals output in accordance with the amounts of light received by one pair of focus detecting sensors (phase difference detecting pixels).

On the assumption that one pair of focus detecting sensors (phase difference detecting pixels) are pixels a and b, the output examples of the pixels a and b are shown in FIG. 2. Lines output from the pixels a and b are signals having a predetermined shift amount Sf.

The shift amount Sf corresponds to a deviation amount from a focus position of the focus lens, that is, a defocus amount. A method of performing focus control on a subject by adjusting the focus lens in accordance with the shift amount Sf is the phase difference detecting method. According to the phase difference detecting method, the high-speed focusing operation can be performed without blurring, since the deviation amount in the focusing direction of the photographing lens can be directly obtained by detecting a relative position deviation amount of the light flux in the division direction.

For example, Japanese Unexamined Patent Application Publication No. 2008-42404 discloses a technique regarding auto-focus performed by detecting a phase difference when photographing a moving image. Japanese Unexamined Patent Application Publication No. 2008-42404 discloses the configuration in which an imaging apparatus having a still image mode of recording a still image and a moving-image mode of recording a moving image determines a lens driving amount from a defocus amount calculated in the phase difference detecting method and automatically determines a lens driving speed.

When the phase difference detecting method disclosed in Japanese Unexamined Patent Application Publication No. 2008-42404 is applied, a subject can be focused smoothly. However, since the moving speed of a lens in a focus operation is automatically determined, a focus operation process, that is, focus control may not be performed while it takes some time in accordance with the preference of a photographer.

### SUMMARY

It is desirable to provide an imaging apparatus, a focus control method, and a program capable of performing advanced focus control to set a focus operation time or speed for a specific subject freely in accordance with the preference of a user.

According to an embodiment of the present disclosure, there is provided an imaging apparatus including: a display unit that displays an image photographed by an imaging element; and a focus control unit that performs focus control of inputting information regarding a selected image region of the image displayed on the display unit and setting a subject contained in the selected image region as a focusing target. The focus control unit performs the focus control by determining a driving speed of a focus lens based on information regarding an operation of a user and moving the focus lens at the determined driving speed of the focus lens.

In the imaging apparatus according to the embodiment of the present disclosure, the focus control unit may perform focus control of determining a driving time of the focus lens in accordance with a tracing time of the user from a focused first image region displayed on the display unit to a second image region, which is a subsequent focusing target, and setting the determined driving time of the focus lens as a movement time of the focus lens.

In the imaging apparatus according to the embodiment of the present disclosure, the focus control unit may determine a driving speed of the focus lens so as to complete a focusing process on a subject of the second image region at the determined driving time of the focus lens and may move the focus lens at the determined driving speed of the focus lens.

In the imaging apparatus according to the embodiment of the present disclosure, the focus control unit may perform focus control of determining a driving time of the focus lens in accordance with a touch continuity time of the user touching an image region, which is a subsequent focusing target, displayed on the display unit and setting the determined driving time of the focus lens as a movement time of the focus lens.

In the imaging apparatus according to the embodiment of the present disclosure, the focus control unit may determine a driving speed of the focus lens so as to complete a focusing process on a subject of the image region, which is the subsequent focusing target, at the determined driving time of the focus lens and may move the focus lens at the determined driving speed of the focus lens.

In the imaging apparatus according to the embodiment of the present disclosure, the focus control unit may perform focus control of determining a driving time and a driving speed of the focus lens in accordance with a tracing time of the user tracing a focused first image region displayed on the display unit to a second image region, which is a subsequent focusing target, and a tracing amount per unit time and moving the focus lens in accordance with the determined driving time and driving speed of the focus lens.

In the imaging apparatus according to the embodiment of the present disclosure, the focus control unit may perform focus control of moving the focus lens at the determined driving time and driving speed of the focus lens so as to complete a focusing process on a subject of the second image region.

In the imaging apparatus according to the embodiment of the present disclosure, the focus control unit may perform focus control of dividing a total time of the tracing time of the user tracing the focused first image region displayed on the display unit to the second image region, which is the subsequent focusing target into a plurality of times, determining a driving speed of the focus lens in a divided time unit in accordance with a tracing amount of the divided time unit, and moving the focus lens in accordance with the determined driving speed of the locus lens in the divided time unit.

In the imaging apparatus according to the embodiment of the present disclosure, the imaging element may perform the focus control in accordance with a phase difference detecting method and include a plurality of AF regions having a phase difference detecting pixel. The focus control unit may select an AF region corresponding to a touch region of the user on the display unit as an AF region which is a focusing target.

According to another embodiment of the present disclosure, there is provided a focus control method performed in an imaging apparatus. The focus control method includes performing, by a focus control unit, focus control of inputting information regarding a selected image region of an image displayed on a display unit and setting a subject contained in the selected image region as a focusing target. The focus control is focus control of determining a driving speed of a focus lens based on information regarding an operation of a user and moving the focus lens at the determined driving speed of the focus lens.

According to still another embodiment of the disclosure, there is provided a program performing focus control in an imaging apparatus. The program causes a focus control unit to perform the focus control of inputting information regarding a selected image region of an image displayed on a display unit and setting a subject contained in the selected image region as a focusing target. In the focus control, the focus control unit performs the focus control by determining a driving speed of a focus lens based on information regarding an operation of a user and moving the focus lens at the determined driving speed of the focus lens.

The program according to the embodiment of the present disclosure is a program that is provided from, for example, a storage medium to an information processing apparatus or a computer system capable of executing, for example, various program codes. The process is realized in accordance with the program by a program executing unit when the information processing apparatus or the computer system executes the program.

The other forms, features, and advantages of the embodiments of the present disclosure are apparent from the detailed description based on embodiments of the present disclosure and the accompanying drawings described below. In the specification, a system is a logical collection of a plurality of apparatuses and is not limited to a configuration where each apparatus is in the same casing.

According to the embodiments of the present disclosure, the apparatus and method realizing the focus control while changing the driving speed of the focus lens are embodied. Specifically, the apparatus includes the focus control unit that performs the focus control of inputting information regarding the selected image region of the display image on the display unit and setting the subject contained in the selected image region as the focusing target. The focus control unit performs the focus control by determining a driving speed of a focus lens based on information regarding an operation of a user and moving the focus lens at the determined driving speed of the focus lens. For example, a tracing time, a tracing amount, a touch continuity time, or the like of a user operating on the display unit is measured, the driving speed of the focus lens is determined based on information regarding the measurement, and the focus lens is moved at the determined driving speed of the focus lens. By this process, a moving image can be reproduced so as to achieve an image effect in which, for example, a process of changing a focus point is performed slowly or rapidly.

### BRIEF DESCRIPTION OF THE DRAWINGS

FIG. 1 is a diagram illustrating a focus control process based on contrast detection;

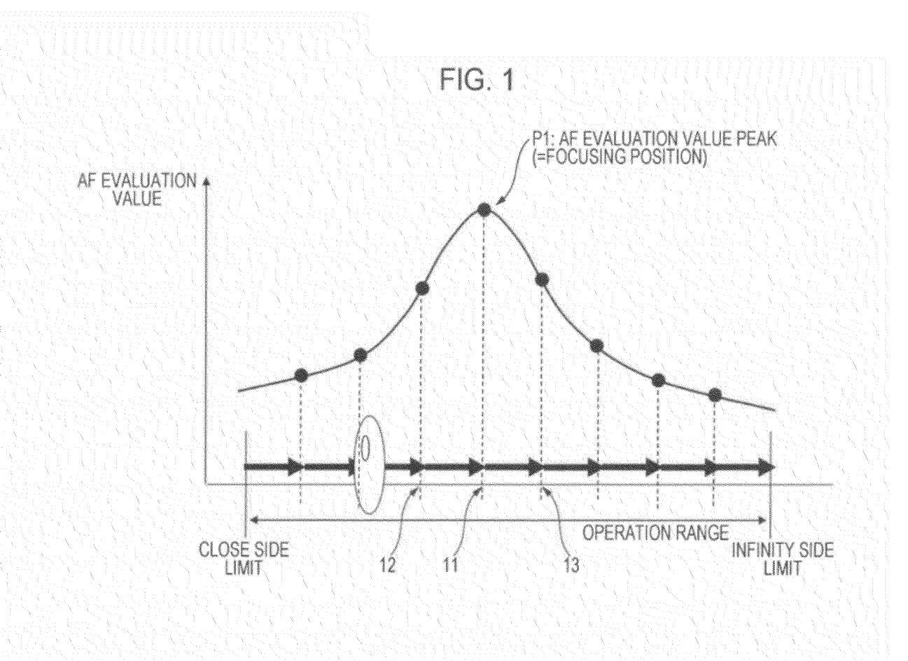

FIG. 2 is a diagram illustrating the focus control process based on phase difference detection;

FIG. 3 is a diagram illustrating an example of the configuration of an imaging apparatus;

FIG. 4 is a diagram illustrating an AF region in an imaging element of the imaging apparatus;

FIG. 5 is a diagram illustrating a focus control process based on phase difference detection;

FIG. 6 is a diagram illustrating the focus control process based on the phase difference detection;

FIGS. 7A to 7C are diagrams illustrating the focus control process based on the phase difference detection;

FIG. 8 is a flowchart illustrating a processing sequence performed in the imaging apparatus;

FIG. 9 is a diagram illustrating an image displayed on a display unit when a moving image is photographed;

FIGS. 10A and 10B are diagrams illustrating an AF control process based on a tracing time of the imaging apparatus;

FIG. 11 is a flowchart illustrating the AF control process based on the tracing time of the imaging apparatus;

FIG. 12 is a flowchart illustrating the AF control process of the imaging apparatus;

FIG. 13 is a flowchart illustrating the AF control process associated with driving speed control of the focus lens performed by the imaging apparatus;

FIG. 14 is a diagram illustrating a correspondence relationship between the driving time and the driving speed in a specific example of the AF control process based on the tracing time of the imaging apparatus;

FIGS. 15A and 15B are diagrams illustrating the AF control process based on a touch ON continuity time of the imaging apparatus;

FIG. 16 is a flowchart illustrating the AF control process based on the touch ON continuity time of the imaging apparatus;

FIGS. 17A and 17B are diagrams illustrating the AF control process based on a tracing time and a tracing amount of the imaging apparatus;

FIG. 18 is a flowchart illustrating the AF control process based on the tracing time and the tracing amount of the imaging apparatus;

FIG. 19 is a flowchart illustrating the AF control process based on the tracing time and the tracing amount of the imaging apparatus; and

FIG. 20 is a diagram illustrating a correspondence relationship between a driving time and a driving speed in a specific example of the AF control process based on the tracing time and the tracing amount of the imaging apparatus.

### DETAILED DESCRIPTION OF EMBODIMENTS

Hereinafter, an imaging apparatus, a focus control method, and a program according to embodiments of the present disclosure will be described in detail with reference to the drawings. The description will be made as follows.

1. Example of Configuration of Imaging Apparatus

2. Selection Mode of AF Region (Auto-focus Region)

3. Focus Control Sequence Performed By Imaging Apparatus

4. Detailed Embodiments of AF Region Selection and AF Driving Time Setting

4-1. (Embodiment 1) AF Control of Controlling Driving Speed of Focus Lens in accordance with Movement Time of User's Finger between AF Regions

4-2. (Embodiment 2) AF Control of Controlling Driving Speed of Focus Lens in accordance with Touch Time of User's Finger on AF Region to Be Newly Focused

4-3. (Embodiment 3) AF Control of Controlling Driving Speed of Focus Lens in accordance with Movement Amount (Distance) of Finger between AF Regions

### 1. Example of Configuration of Imaging Apparatus

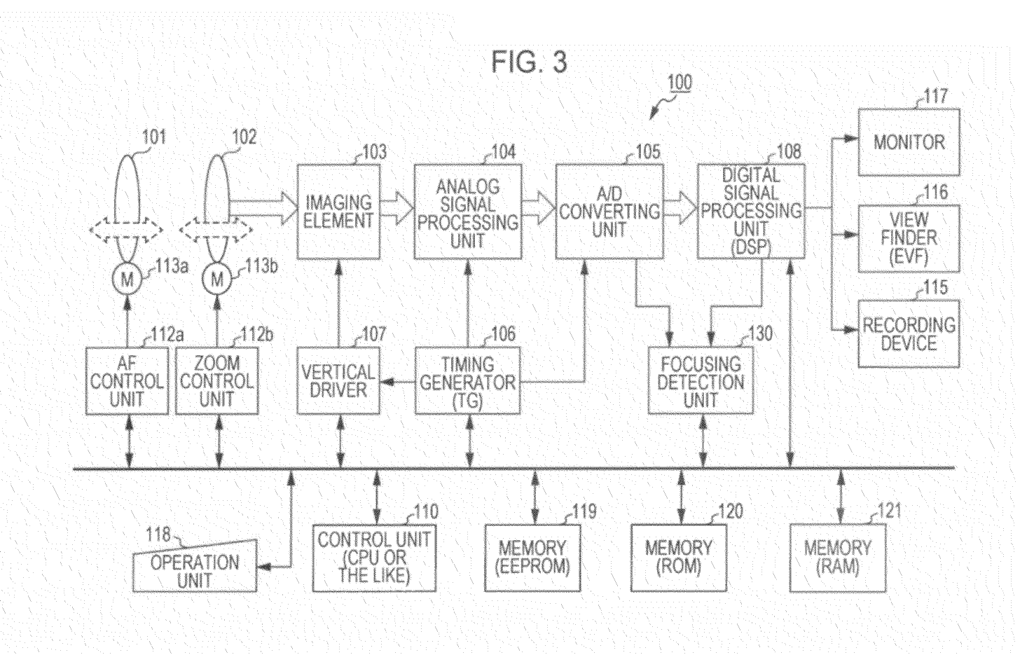

First, the inner configuration of an imaging apparatus (camera) 100 according to an embodiment of the present disclosure will be described with reference to FIG. 3. The imaging apparatus according to the embodiment of the present disclosure is an imaging apparatus that has an auto-focus function.

Light incident via a focus lens 101 and a zoom lens 102 is input to an imaging element 103 such as a CMOS or a CCD and is photoelectrically converted by an imaging element 103. The photoelectrically converted data is input to an analog signal processing unit 104, is subjected to noise removal or the like by the analog signal processing unit 104, and is converted into a digital signal by an A/D conversion unit 105. The data digitally converted by the A/D conversion unit 105 is recorded in a recording device 115 configured by, for example, a flash memory. Further, the data is displayed on a monitor 117 or a viewfinder (EVF) 116. An image formed through a lens is displayed as a through image on the monitor 117 and the viewfinder (EVF) 116 irrespective of photographing.

An operation unit 118 is an operation unit that includes an input unit, such as a shutter or a zoom button provided in a camera body, configured to input various kinds of operation information and a mode dial configured to set a photographing mode. A control unit 110, which includes a CPU, controls various processes performed by the imaging apparatus in accordance with programs stored in advance in a memory (ROM) 120. A memory (EEPROM) 119 is a non-volatile memory that stores image data, various kinds of auxiliary information, programs, and the like. The memory (ROM) 120 stores the programs, arithmetic parameters, or the like used by the control (CPU) 110. A memory (RAM) 121 stores programs used by the control (CPU) 110, an AF control unit 112a, or the like and parameters appropriately changed in the execution of the programs.

The AF control unit 112a drives a focus lens driving motor 113a set to correspond to the focus lens 101 and performs auto-focus control (AF control). A zoom control unit 112b drives a zoom lens driving motor 113b set correspond to the zoom lens 102. A vertical driver 107 drives the imaging element (CCD) 103. A timing generator 106 generates control signals for processing timings of the imaging element 103 and the analog signal processing unit 104 and controls the processing timings of the imaging element 103 and the analog signal processing unit 104.

Further, the focus lens 101 is driven in an optical axis direction under the control of the AF control unit 112a.

In the imaging element 103, a sensor is used which includes a plurality of general pixels, which include a photodiode or the like and are arranged two-dimensionally in a matrix form and in which, for example, R (Red), G (Green), and B (Blue) color filters with different spectral characteristics are arranged at a ratio of 1:2:1 on the light-receiving surfaces of the respective pixels, and phase difference detecting pixels configured to detect focus by pupil-dividing subject light.

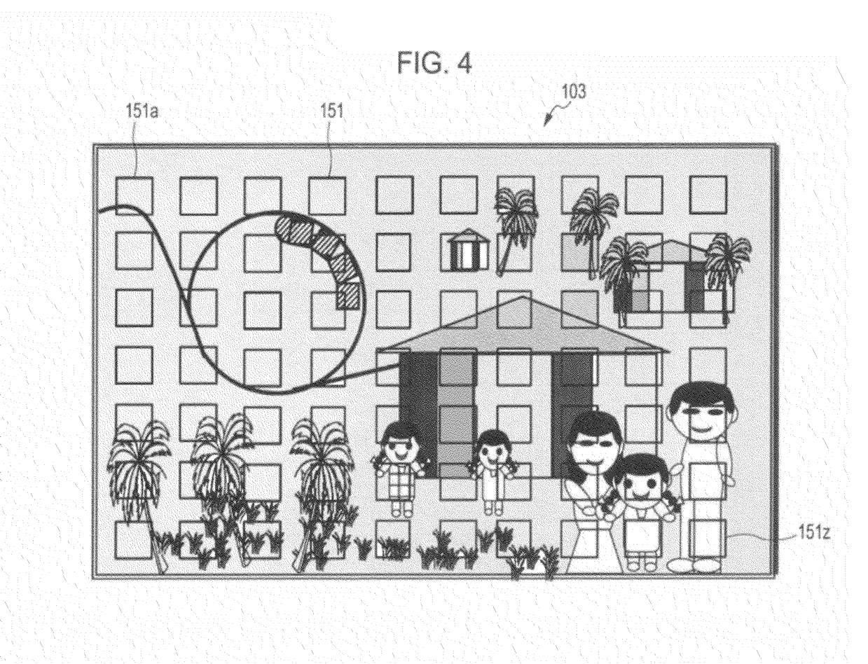

The imaging element 103 generates analog electric signals (image signals) for R (Red), G (Green), and B (Blue) color components of a subject image and outputs the analog electric signals as image signals of the respective colors. Moreover, the imaging element 103 also outputs phase difference detection signals of the phase difference detecting pixels. As shown in FIG. 4, the imaging element 103 has a plurality of AF regions 151 defined in a matrix form on an imaging surface. The phase difference detecting pixels are set at the AF regions 151, respectively, such that a focus is detected at each of the AF regions 151 by a phase difference detecting method. That is, the imaging element 103 is configured such that a focusing process can be performed in the unit of the AF region 151, that is, a focusing operation can be performed on a subject contained in each AF region in the unit of the AF region 151.

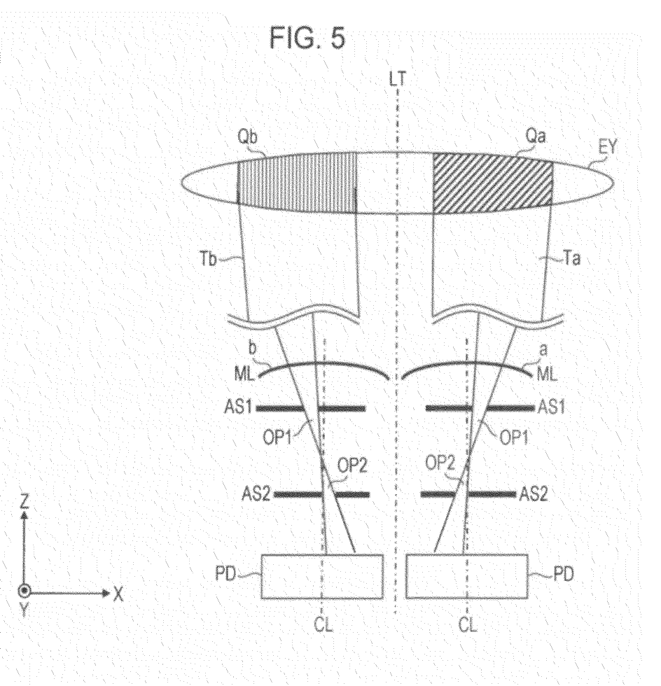

The overview of a focus detecting process of the phase difference detecting method will be described with reference to FIGS. 5 to 7C.

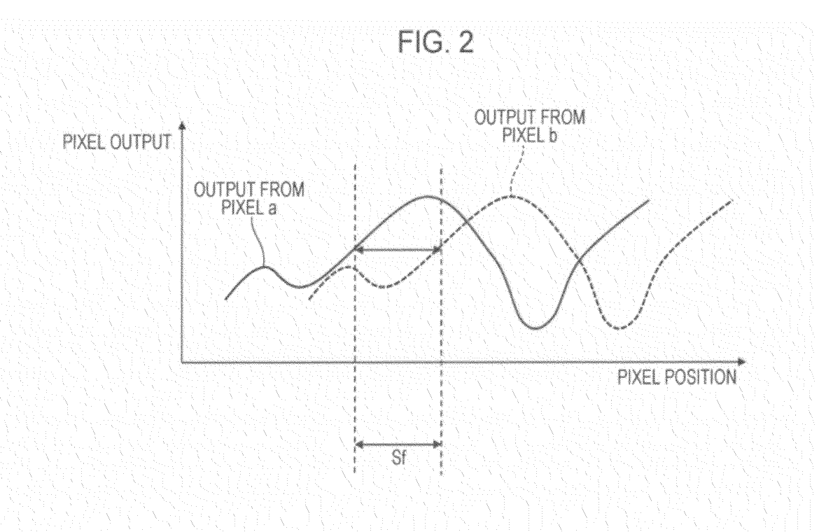

According to the phase difference detecting method, as described above with reference to FIG. 2, the defocus amount of the focus lens is calculated based on the deviation amounts of the signals output in accordance with the light-receiving amounts of one pair of focus detecting sensors (phase difference detecting pixels) and the focus lens is set at the focus position based on the defocus amount.

Hereinafter, light incident on pixels a and b, which are one pair of focus detecting sensors (phase difference detecting pixels) set at the AF regions 151 in FIG. 4, will be described in detail with reference to FIG. 5.

In a phase difference detecting unit, as shown in FIG. 5, one pair of phase difference detecting pixels 211a and 211b are arranged horizontally which receive a light flux Ta from a right portion Qa (also referred to as a “right partial pupil region” or simply referred as a “right pupil region”) of an exit pupil EY of the photographing optical system and a light flux Tb from a left portion Qb (also referred to as “left partial pupil region” or simply referred to as a “left pupil region”) of the exit pupil EY of the photographing optical system. Here, the +X direction and the −X direction in the drawing is expressed as the right side and left side, respectively.

Between one pair of phase difference detecting pixels 211a and 211b, one phase difference detecting pixel (hereinafter, also referred to as a “first phase difference detecting pixel”) 211a includes a micro-lens ML condensing light incident on the first phase difference detecting pixel 211a, a first light-shielding plate AS1 having a first opening portion OP1 with a slit (rectangular) shape, a second light-shielding plate AS2 disposed below the first light-shielding plate AS1 and having a second opening portion OP2 with a slit (rectangular) shape, and a photoelectric conversion unit PD.

The first opening portion OP1 of the first phase difference detecting pixel 211a is disposed at a position deviated in a specific direction (here, the right side (+X direction)) with reference to (from) a center axis CL which passes through the center of the light-receiving element PD and is parallel to an optical axis LT. Further, the second opening portion OP2 of the first phase difference detecting pixel 211a is disposed at a position deviated in an opposite direction (also referred to as an “opposite specific direction”) to the specific direction with reference to the center axis CL.

Between one pair of phase difference detecting pixels 211a and 211b, the other phase difference detecting pixel (here, also referred to as a “second phase difference detecting pixel”) 211b includes a first light-shielding plate AS1 having a first opening portion OP1 with a slit shape and a second light-shielding plate AS2 disposed below the first light-shielding plate AS1 and having a second opening OP2 with a slit. The first opening OP1 of the second phase difference detecting pixel 211b is disposed at a position deviated in an opposite direction to the specific direction with reference to a center axis CL. Further, the second opening OP2 of the second phase difference detecting pixel 211b is disposed at a position deviated in the specific direction with reference to the center axis CL.

That is, the first opening portions OP1 of one pair of phase difference detecting pixels 211a and 211b are disposed at the positions deviated in the different directions. Further, the second opening portions OP2 of the phase difference detecting pixels 211a and 211b are respectively disposed in the directions different from the directions in which the corresponding first opening portions OP1 are deviated.

One pair of phase difference detecting pixels a and b with the above-described configuration acquire subject light passing through the different regions (portions) of the exit pupil EY.

Specifically, the light flux Ta passing through the right pupil region Qa of the exit pupil EY passes through the micro-lens ML corresponding to the first phase difference detecting pixel a and the first opening portion OP1 of the first light-shielding plate AS1, is restricted (limited) by the second light-shielding plate AS2, and then is received by the light-receiving element PD of the first phase difference detecting pixel a.

Further, the light flux Tb passing through the left pupil region Qb of the exit pupil EY passes through the micro-lens ML corresponding to the second phase difference detecting pixel b and the first opening portion OP1 of the first light-shielding plate AS1, is restricted (limited) by the second light-shielding plate AS2, and then is received by the light-receiving element PD of the second phase difference detecting pixel b.

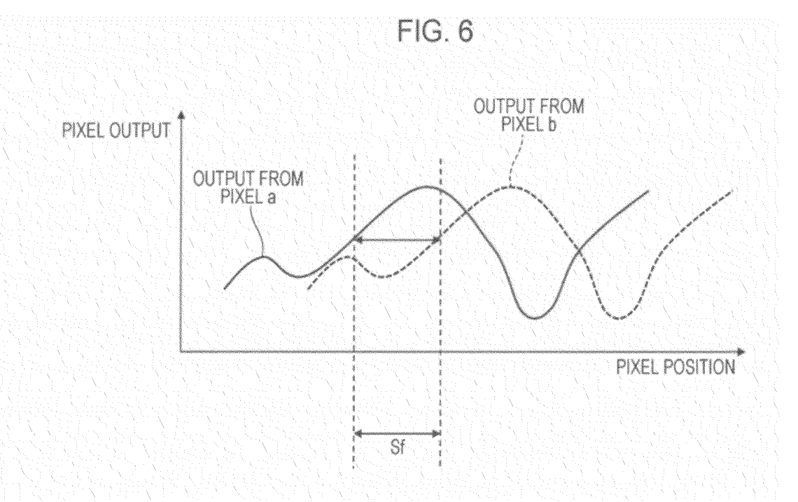

Examples of the acquired outputs of the light-receiving elements in the pixels a and b are shown in FIG. 6. As show in FIG. 6, an output line from the pixel a and an output line from the pixel b are signals that have a predetermined shift amount Sf.

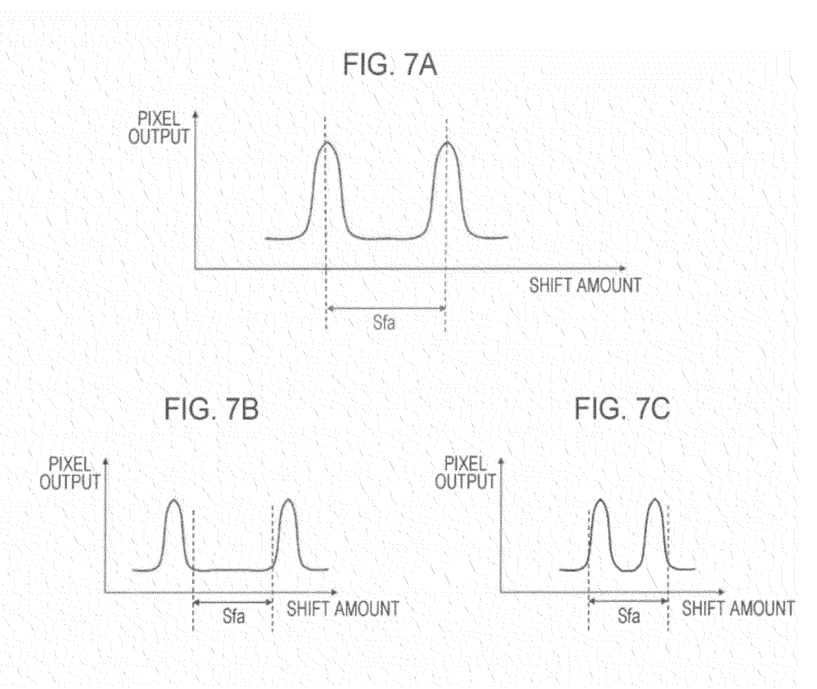

FIG. 7A shows a shift amount Sfa generated between the pixels a and b, when the focus lens is set at a position matching a subject distance and focus is achieved, that is, in a focused state.

FIGS. 7B and 7C show shift amounts Sfa generated between the pixels a and b, when the focus lens is not set at a position matching the subject distance and the focus is not achieved, that is, in an unfocused state.

FIG. 7B shows an example in which the shift amount is larger than that of the focusing time and FIG. 7C shows an example in which the shift amount is smaller than that of the focusing time.

As in FIGS. 7B and 7C, the focus lens may be moved and focused so that the shift amount becomes the shift amount of the focusing time.

This process is a focusing process performed in accordance with the “phase difference detecting method.”

The focus lens can be set at the focus position through the focusing process in accordance with the “phase difference detecting method” and the focus lens can be set at the position matching the subject distance.

The shift amount described with reference to FIGS. 7A to 7C can be measured in the unit of the pair of pixels a and b which are the phase difference detecting elements set in each AF region 151 shown in FIG. 4. Moreover, the focus position (focus point) on a subject image photographed at this minute region (combination region of the pixels a and b) can be individually determined.

For example, when one AF region 151a located at the left upper position among the plurality of AF regions 151 shown in FIG. 4 is used to perform focus control, the focus control of focusing the subject contained in the AF region 151a can be performed.

Likewise, when one AF region 151z located at the right lower position among the plurality of AF regions 151 shown in FIG. 4 is used to perform the focus control, the focus control of focusing the subject contained in the AF region 151z can be performed.

By performing the focus control by detection of the phase difference, the focus control, that is, a focusing operation (setting the focused state) can be performed in the unit of a partial region of an image photographed by the imaging element.

The AF control unit 112a shown in FIG. 3 detects the defocus amount corresponding to the AF region selected from the plurality of AF regions 151 arranged on the imaging surface shown in FIG. 4 by the auto-focus control at the auto-focus time and obtains the focus position of the focus lens 101 with respect to the subject contained in the selected AF region. Then, the focus lens 101 is moved to the focus position to obtain the focused state.

As described below, the AF control unit 112a performs various controls of a movement time or a movement speed of the focus lens 101. That is, the AF control unit 112a changes the driving speed of the focus lens in accordance with the defocus amount of the AF region based on operation information of a user and moves the focus lens. This process will be described below in detail.

A focus detecting unit 130 calculates the defocus amount using a phase difference detecting pixel signal from the A/D conversion unit 105. By setting the defocus amount in a predetermined range including 0, the focused state is detected.

### 2. Selection Mode of AF Region (Auto-Focus Region)

Next, a selection mode of the AF region (Auto-Focus region) will be described. The selection mode (focus area mode) of the AF region performed by the AF control unit 112a includes three types of modes:

(1) a local mode;

(2) a middle fixed mode; and

(3) a wide mode.

In the local mode, for example, auto-focus is performed at one AF region selected by a user which is a photographer. That is, the auto-focus is performed by selecting a subject, which is contained in, for example, one AF region 151x selected from the plurality of AF regions 151a to 151z shown in FIG. 4 by the photographer, as a focusing target, that is, a focus operation target.

Information regarding the AF region selected by the photographer is stored as a local AF region set value in, for example, the memory (RAM) 121.

In the middle fixed mode, the auto-focus is performed by selecting a subject contained in the AF region located at the middle of the imaging surface as a focusing target, that is, a focus operation target.

In the wide mode, the AF region is automatically selected and the auto-focus is performed at the AF region by determining a subject distance, a face recognition result, a horizontal or vertical state of the imaging apparatus, and the like.

### 3. Focus Control Sequence Performed by Imaging Apparatus

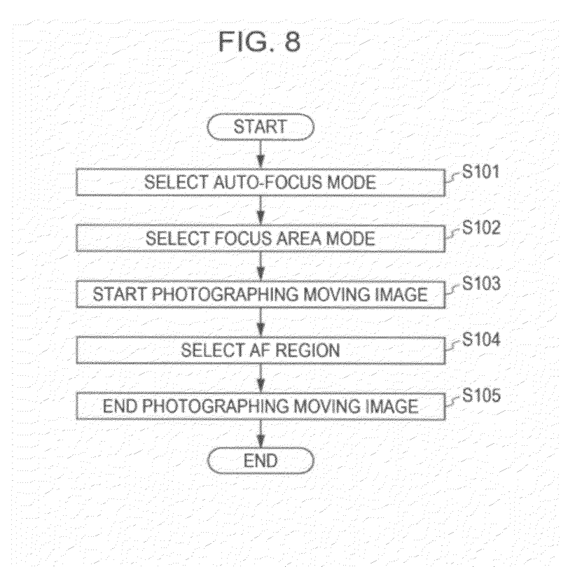

Next, a focus control sequence performed by the imaging apparatus will be described with reference to the flowcharts of FIG. 8 and the subsequent drawings.

The flowcharts described below are executed in sequences defined in programs stored in, for example, the memory (ROM) 119 under the control of the control unit 110 or the AF control unit 112a shown in FIG. 3.

The overall sequence of an image photographing process performed by the imaging apparatus will be described with reference to the flowchart of FIG. 8.

In step S101, the operation information of a user operating a focus mode SW (switch) of the operation unit 118 is first input and the auto-focus mode is selected.

The focus mode SW is a SW configured to select manual focus or auto-focus.

In step S102, operation information of the user operating a menu button or the like of the operation unit 118 is input and the focal mode selected as the focus area mode. As described above, the selection mode (focus area mode) of the AF region performed by the AF control unit 112a includes three modes: (1) the local mode, (2) the middle fixed mode, and (3) the wide mode. Here, it is assumed that (1) the local mode is selected for control.

In the local mode, the auto-focus is performed at one AF region selected by the photographer. That is, the auto-focus is performed by selecting the subject contained in one AF region 151x selected from the plurality of regions 151a to 151z shown in FIG. 4 by the photographer as the focusing target, that is, the focus operation target.

Next, in step S103, photographing a moving image is started, for example, when information regarding the fact that the user presses down a moving-image button of the operation unit 118 is input.

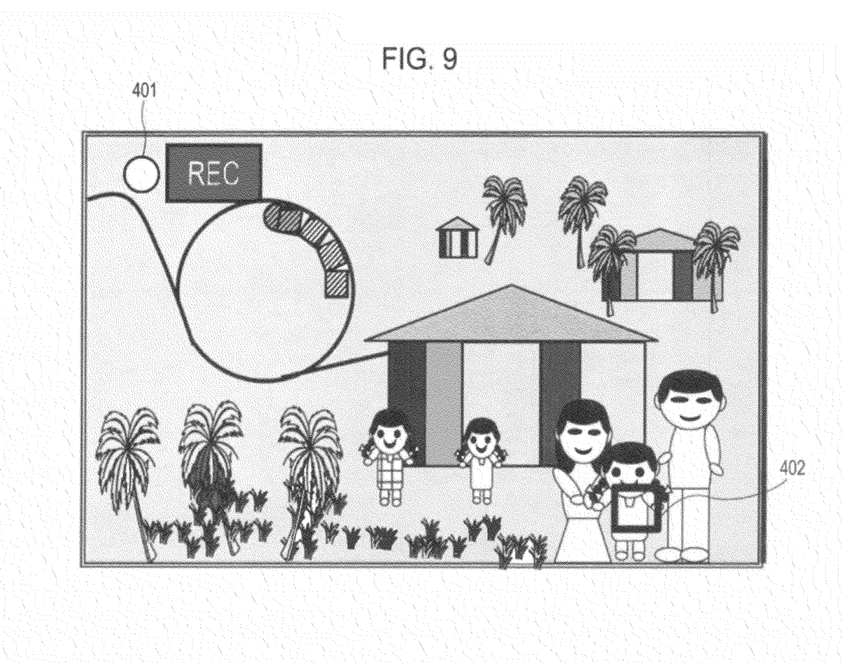

As shown in FIG. 9, the fact that the moving image is being photographed is displayed on the monitor 117 or the like by an icon 401 indicating that the moving image is being photographed.

At this time, an AF frame 402 indicating the focused state of one AF region selected by the user or in the default setting is displayed. As shown in FIG. 9, the selected one AF frame 402 is displayed in a display form (for example, a green frame display) indicating the focused state. When the focused state is not achieved, the AF frame is displayed in a display form (for example, a black frame display) indicating that the focused state is not achieved. Further, the AF frame 402 in the focused state is displayed with a white color to realize white and black color display.

Next, in step S104, the user sequentially sets the image regions desired to be focused, that is, the AF regions to be subjected to the auto-focus while observing an image displayed on the monitor 117. For example, when the monitor 117 is a touch panel, the user touches a region desired to be focused in the image displayed on the monitor 117 with his or her finger to select the AF region near the touched regions.

Further, the imaging apparatus according to this embodiment controls the movement time or the movement speed of the focus lens when the AF region is changed. That is, the auto-focus operation is realized more freely by controlling the AF driving time or speed. This process will be described below in detail.

Finally, in step S105, photographing the moving image is ended when inputting information regarding the fact that the user presses down the moving-image button of the operation unit 118 is detected.

### 4. Detailed Embodiments of AF Region Selection and AF Driving Time Setting

Next, detailed embodiments of AF region selection and AF driving time setting will be described.

In the local mode, as described above, the user sequentially can set the image regions desired to be focused, that is, the AF regions to be subjected to the auto-focus while observing an image displayed on the monitor 117.

For example, when the user selects a region that the user desires to operate the focusing operation on the image displayed on the monitor 117 configured as a touch panel and touches the region with his or her finger, the AF control unit 112a selects the AF region near the finger-touched position as the AF region to be focused and performs non-focus control.

Hereinafter, AF control of changing a focus point from a first AF control position (focused position) containing a first subject selected as a first focusing target to a second AF control position (focused position) containing a second subject selected as a second focusing target will be described according to a plurality of embodiments.

Hereinafter, embodiments will be described in sequence.

4-1. (Embodiment 1) AF Control of Controlling Driving Speed of Focus Lens in accordance with Movement Time of User's Finger between AF Regions
4-2. (Embodiment 2) AF Control of Controlling Driving Speed of Focus Lens in accordance with Touch Time of User's Finger on AF Region to Be Newly Focused
4-3. (Embodiment 3) AF Control of Controlling Driving Speed of Focus Lens in accordance with Movement Amount (Distance) of User's Finger between AF Regions

### 4-1. Embodiment 1

### AF Control of Controlling Driving Speed of Focus Lens in Accordance with Movement Time of User's Finger Between AF Regions

First, AF control of controlling the driving speed of the focus lens in accordance with a movement time of a user's finger between AF regions will be described according to Embodiment 1.

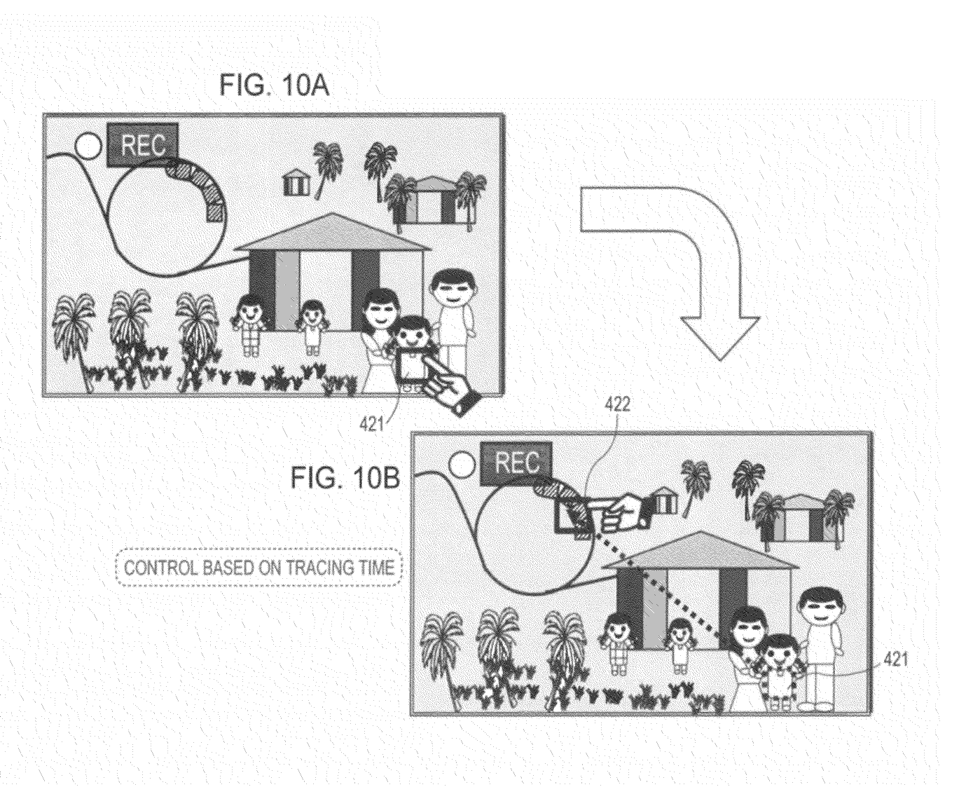

In the AF control according to this embodiment, the AF control unit 112a controls an AF control position (focus position) such that a first AF frame 421 of a first AF region set as a start position is changed to a second AF frame 422 of a second AF region, when the user traces the touch panel, that is, slides his or her finger on the touch panel while touching the touch panel with the his or her finger, for example, as shown in FIGS. 10A and 10B.

Further, the AF control unit 112a controls an AF control time in accordance with the setting of the user when the AF control unit 112a performs the AF control position (focus position) changing process. That is, the AF control unit 112a controls the AF control time by lengthening or shortening that a transition time from the focused state of the subject in the first AF frame 421 to the focused state of the subject in the second AF frame 422. This process makes it possible to achieve an image effect in which a process of changing the focus from a subject A to a subject B is performed slowly or rapidly, for example, when a moving image is reproduced.

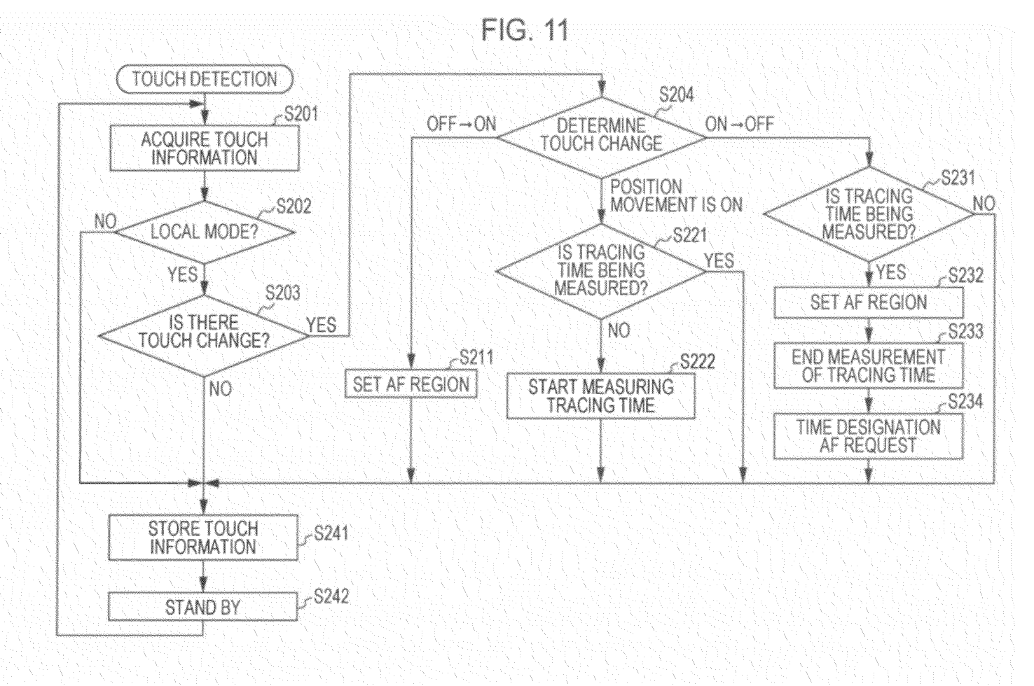

The sequence of the focus control process will be described with reference to the flowcharts of FIG. 11 and the subsequent drawings.

In step S201, the AF control unit 112a acquires information regarding touch of the user touching the touch panel (the monitor 117) of the operation unit 118.

The information regarding the touch includes (1) a touch state (2) information regarding the touch position of the user's finger.

The (1) touch state is identification information of two states: (1a) a touch ON state where the finger of the user or the like is touched on the touch panel and (1b) a touch OFF state where the finger of the user or the like is not touched on the touch panel.

The (2) information regarding the touch position is detected as coordinate data (x, y) on, for example, an XY two-dimensional coordinate plane of the touch panel.

The information regarding the touch acquired in step S201 includes (1) the touch state and (2) the touch position information.

Next, in step S202, the setting mode of the focus area mode is confirmed. That is, it is confirmed whether the focus area mode is set to one of (1) the local mode, (2) the middle fixed mode, and (3) the wide mode.

When the focus area mode is set to the local mode, the process proceeds to step S203.

On the other hand, when the focus area mode is not set to the local mode, the process proceeds to step S241 and the information regarding the touch is stored in the memory unit (for example, the memory (RAM) 121).

When it is confirmed that the local mode is set in step S202, the process proceeds to step S203 to determine the touch state (ON/OFF) of the touch panel and the change state of the touch position.

In the local mode, as described above, the auto-focus is performed at one AF region selected by the photographer. That is, the auto focus is performed by setting the subject, which is contained in one AF region 151x selected from the plurality of regions 151a to 151z shown in FIG. 4 by the photographer, as the focusing target, that is, the focus operation target.

In step S203, when the latest touch state or touch position on the touch panel is not substantially identical with the previously detected touch state (ON/OFF) or the previous touch position stored in the storage unit (for example, the memory (RAM) 121), the process proceeds to step S204. The process shown in FIG. 11 is performed repeatedly every predetermined standby time of a standby step of step S242. The standby time is, for example, 100 ms and the process is performed repeatedly at an 100 ms interval.

On the other hand, when both the latest touch state and touch position on the touch panel are identical with the previously detected touch state and previous touch position, the process proceeds to step S241 and the information regarding the touch is stored in the storage unit (for example, the memory (RAM) 121).

When it is determined that the latest touch state or touch position on the touch panel is not identical with at least one of the previous touch states or the previous touch positions stored in the storage unit (for example, the memory (RAM) 121) in step S203, the touch state change and the touch position change are determined in step S204.

When the previous touch state is determined to the touch OFF and the latest touch state is determined to the touch ON in step S204, the process proceeds to step S211.

When the previous touch state is determined to the touch ON, the latest touch state is determined to the touch ON, and the latest touch position is not identical with the pervious touch position in step S204, the process proceeds to step S221.

When the previous touch state is determined to the touch ON and the latest touch state is determined to the touch OFF in step S204, the process proceeds to step S231.

When the previous touch state is determined to the touch OFF and the latest touch state is determined to the touch ON in the determination process of step S204, the AF region corresponding to the latest touch position of the user is extracted in step S211 and is stored as a “first local AF region identifier” in the storage unit (for example, the memory (RAM) 121.

An AF region identification value refers to, for example, data used to identify the AF region indicating on which AF region the user touches among the plurality of AF regions 151a to 151z shown in FIG. 4.

Further, the “first local AF region identifier” is an identifier of the AF region which the user initially touches with his or her finger. For example, in the example of FIGS. 10A and 10B, the first local AF region identifier corresponds to the AF region where the AF frame 421 is set.

On the other hand, when the previous touch state is determined to the touch ON and the latest touch state is determined to the touch ON in the determination process of step S204, it is determined whether a “tracing time” is measured in step S221.

The “tracing time” refers to, for example, a movement time of the user's finger from the AF frame 421 shown in FIGS. 10A and 10B to the AF frame 422.

When it is determined that the “tracing time” is not measured, the process proceeds to step S222 to start measuring the tracing time.

When the “tracing time” is being measured, the process proceeds to step S241 to store the information regarding the touch in the storage unit (for example, the memory (RAM) 121).

On the other hand, when the previous touch state is determined to the touch ON and the latest touch state is determined to the touch OFF in the determination process of step S204, it is determined whether the “tracing time” is being measured in step S231.

When it is determined that the “tracing time” is being measured, the process proceeds to step S232. On the other hand, when it is determined that the “tracing time” is not being measured, the process proceeds to step S241 to store the information regarding the touch in the storage unit (for example, the memory (RAM) 121).

When it is determined that the “tracing time” is being measured in step S231 and the process proceeds to step S232, the AF region corresponding to the latest touch position is detected. That is, a “second local AF region identifier”, which is the identifier of an AF region distant from the user's finger, and is stored in the storage unit (for example, the memory (RAM) 121).

Then, the measurement of the “tracing time” ends in step S233. The measured “tracing time” is stored as an “AF driving time set value” in the storage unit (for example, the memory (RAM) 121).

Further, the “second local AF region identifier” refers to the identifier of an AF region where the user's finger is distant from the touch panel and is an AF region where a subject which is the subsequent focusing target is contained. For example, in the example of FIGS. 10A and 10B, the AF frame 422 corresponds to the set AF region.

In step S234, the AF control unit 112a sets a “time designation AF operation request.”

The “time designation AF operation request” refers to a request for performing a process of applying the measured “tracing time”, adjusting the focus control time, and performing an AF operation. Further, information indicating whether the request is made may be stored as bit values in the memory (RAM) 121 such that [1]=request and [0]=no request.

When the “time designation AF operation request” is made, the focus control is performed by reflecting the “tracing time.” The sequence of this process will be described below.

For example, the focus control is an AF operation of controlling a transition time from the focused state of the AF frame 421 shown in FIGS. 10A and 10B to the focused state of the AF frame 422 in accordance with the “tracing time.”

Step S241 is a step in which the touch state and the touch position are stored as the previous touch state and the previous touch position in the storage unit in the storage unit (for example, the memory (RAM) 121).

Step S242 is a step in which the AF control unit 112a stands by during a predetermined standby time (for example, 100 ms), since the touch panel process is performed at, for example, an 100 ms interval. After the standby, the process returns to step S201 and the same processes are repeated.

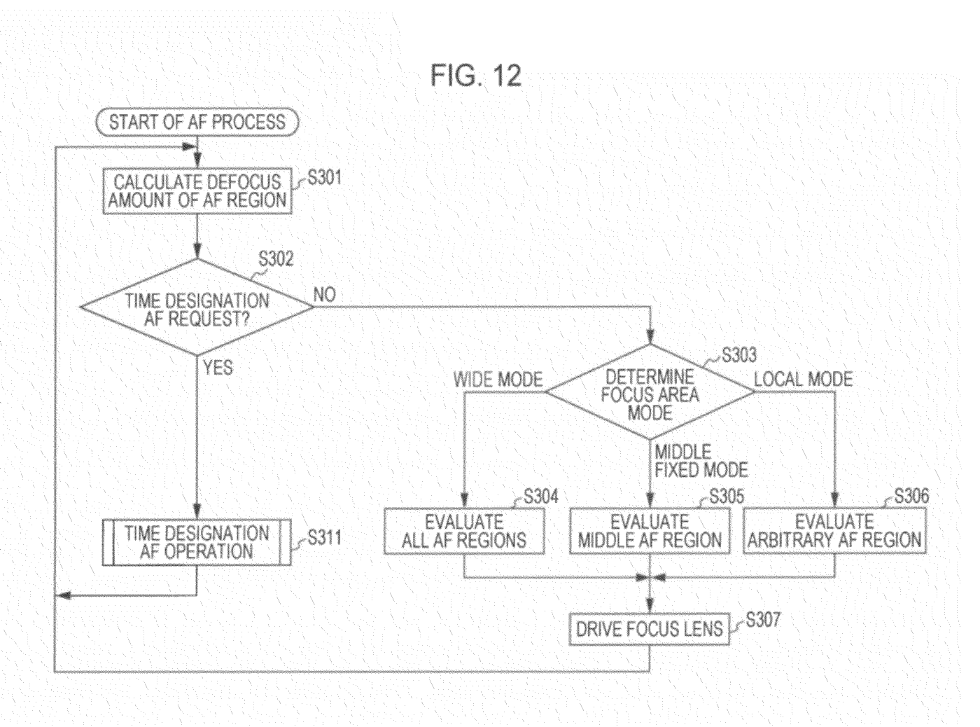

Next, the sequence of the AF control process performed by the AF control unit 112a during the photographing of a moving image will be described with reference to the flowchart of FIG. 12.

In step S301, the focus detecting unit 130 calculates the defocus amounts of all the AF regions, that is, the defocus amounts corresponding to deviation amounts from the focus positions.

Specifically, for example, the defocus amount corresponding to each AF region is calculated based on phase difference detection information from each AF region 151 shown in FIG. 4.

Next, in step S302, it is determined whether a “time designation AF operation request” is made. When it is determined that the “time designation AF operation request” is not made, the process proceeds to step S303. On the other hand, when it is determined that the “time designation AF operation request” is made, the process proceeds to step S311.

The “time designation AF operation request” refers to a request set in step S234 of the flowchart described above with reference to FIG. 11. That is, the “time designation AF operation request” is a request for performing a process of applying the “tracing time”, adjusting the focus control time, and performing the AF operation.

On the other hand, when it is determined that the “time designation AF operation request” is not made and the process proceeds to step S303, the set mode of the focus area mode is confirmed in step S303. That is, it is confirmed whether the focus area mode is set to one of (1) the local mode, (2) the middle fixed mode, and (3) the wide mode.

When the focus area mode is the wide ode, the process proceeds to step S304. When the focus area mode is the middle fixed mode, the process proceeds to step S305. When the focus area mode is the local mode, the process proceeds to step S306.

When the focus area mode is the wide mode, the AF control unit 112a selects an AF region to be focused from all of the AF regions in step S304.

The AF region selecting process is performed in accordance with a preset processing sequence set in advance by the AF control unit 112a. For example, the AF control unit 112a determines a subject distance or a face recognition result and a horizontal or vertical state of the imaging apparatus and selects an AF region as a focusing target. After performing the AF region selecting process, the AF control unit 112a calculates the driving direction and the driving amount of the focus lens 101 from the defocus amount of the selected AF region and drives the focus lens 101 so that the subject of the selected F region is focused in step S307.

When the focus area mode is the middle fixed mode, the process proceeds to step S305. In step S305, the AF control unit 112a selects an AF region located at the middle of the imaging surface as a focusing target. Further, the AF control unit 112a calculates the driving direction and the driving amount of the focus lens 101 from the defocus amount of the AF region located at the middle of the imaging surface and drives the focus lens 101 so that the subject of the AF region located at the middle of the imaging surface is focused in step S307.

When the focus area mode is the local mode, the process proceeds to step S306. In step S306, the AF control unit 112a selects an AF region selected by the photographer as the focusing target. Further, the AF control unit 112a calculates the driving direction and the driving amount of the focus lens 101 from the defocus amount of the AF region selected by the user and drives the focus lens 101 so that the subject of the AF region selected by the user is focused in step S307.

The movement speed of the focus lens 101 in step S307 is a predetermined standard movement speed.

On the other hand, when it is determined that the “time designation AF operation request” is made in step S302, the process proceeds to step S311.

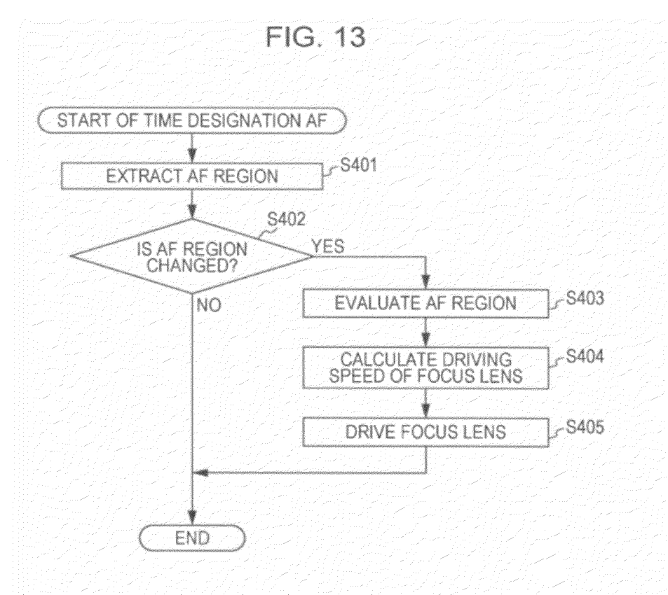

In step S311, a time designation AF operation is performed. The detailed sequence of the time designation AF operation will be described with reference to the flowchart of FIG. 13.

In step S401, the “second local AF region identifier” stored in the storage unit (for example, the memory (RAM) 121) is acquired.

The “second local AF region identifier” refers to information regarding the position of the AF region which is the subsequent focusing target. For example, the AF frame 422 shown in FIGS. 10A and 10B is identification information of the set AF region.

Next, in step S402, the “first local AF region identifier” is compared to the “second local AF region identifier.”

Further, the “first local AF region identifier is a local region where the focusing process is completed and the “second local AF region identifier” is a local region where the focusing process is being currently performed.

In Embodiment 1, the “first local AF region identifier” is the AF region (for example, the AF region corresponding to the AF frame 421 shown in FIGS. 10A and 10B) of the position where the touch of the user's finger is changed from ON to OFF and the user thus starts touching the touch panel with his or her finger.

The “second local AF region identifier” is the AF region (for example, the AF region corresponding to the AF frame 422 shown in FIGS. 10A and 10B) of the position where the touch of the user's finger is changed from ON to OFF and the user detaches his or her finger from the touch panel.

Both the “first local AF region identifier” and the “second local AF region identifier” are identical with each other, the process ends.

For example, when the user's finger stays in the AF frame 421 in the setting shown in FIGS. 10A and 10B, it is determined that the local AF region set value and the driving time designation local AF region set value are identical with each other. In this case, since the AF region as the focusing target is not changed, no new process is performed and the process ends.

On the other hand, in step S402, when it is determined that “first local AF region identifier” and the “second local AF region identifier” are different from each other, the process proceeds to step S403.

The step corresponds to a case where the user's finger is moved from the set AF region of the AF frame 421 to the set AF region of the AF frame 422 in the setting shown in FIGS. 10A and 10B.

In step S403, the AF control unit 112a determines the AF region specified by the “second local AF region identifier” as the subsequent focus control target AF region and calculates the driving direction and the driving amount of the focus lens 101 from the defocus amount of the AF region specified by the “second local AF region identifier.” That is, for example, in the setting shown in FIGS. 10A and 10B, the AF control unit 112a sets the AF region where the AF frame 422 designated as a new focusing target appears as the focusing target and calculates the driving direction and the driving amount of the focus lens 101 from the defocus amount of the AF region.

Further, in step S404, the AF control unit 112a calculates a driving speed (v) from an AF driving time set value (t) stored in advance in the storage unit (for example, the memory (RAM) 121) and the driving amount (d) calculated by the AF control unit 112a.

It is assumed that an addition-subtraction speed of the focus driving which depends on a lens is a fixed value A.

The AF driving time set value (t) corresponds to the “tracing time” set by the user. Further, the “tracing time” may satisfy, for example, an equation below:

AF driving time set value (t)=“tracing time.”

Further, the AF driving time set value (t) may be set by corresponding to “tracing time” ranges partitioned by predetermined threshold values as follows:

AF driving time set value (t)=T1 when Tha≦“tracing time”<Thb;

AF driving time set value (t)=T2 when Thb≦“tracing time”<Thc; and

AF driving time set value (t)=T3 when Thc≦“tracing time”<Thd.

As examples of the above settings, for example, the following settings can be made:

AF driving time set value t=TL corresponding to slow focus control;

AF driving time set value t=TM corresponding to standard focus control; and

AF driving time set value t=TF corresponding to fast focus control.

The driving amount (d) refers to a driving amount of the focus lens necessary for the process of focusing the AF region which is specified by the “second local AF region identifier” and is a focus control target. The driving amount (d) is calculated by the AF control unit 112a.

A relation equation between the driving time (t), the driving speed (v), and the driving amount (d) is as follows;

d=((v/A)×2×v÷2)+(t−(v/A)×2)×v.

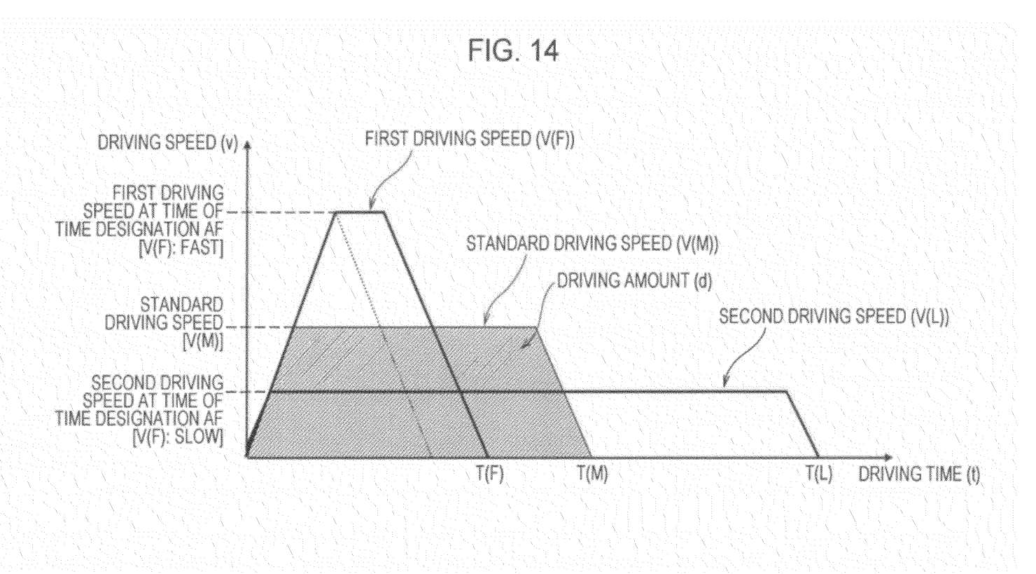

An example of a specific focus control process will be described with reference to FIG. 14.

In FIG. 14, the horizontal axis represents the driving time of the focus lens and the vertical axis represents the driving speed of the focus lens.

The standard time of the AF driving time set value (t) is assumed to be a standard time T(M). The driving speed of the focus lens at the standard time T(M) is assumed to be a standard driving speed V(M).

In the settings, the AF control unit 112a determines the AF driving time set value (t) based on the “tracing time” of the user.

For example, it is assumed that the user slows executes the tracing process, and thus the “tracing time” is long. Further, it is assumed that the AF driving time set value (t) is set to a time T(L) shown in FIG. 14.

As apparent from the drawing, the “AF driving time set value (t)=T(L)” is longer than the standard time T(M).

In this case, the driving speed of the focus lens 101 is set to the second driving speed V(L) shown in FIG. 14, and thus is set to be slower than the standard driving speed V(M).

That is, the focus lens is slowly moved at the second driving speed V(L) to set the focused state from the focused state of a subject in the first AF frame 421 to the focused state of a subject in the second AF frame 422. As a consequence, the transition time from the focused state of the subject in the first AF frame 421 to the focused state of the subject in the second AF frame 422 is T(L), and thus the subject in the AF region corresponding to the second AF frame 422 is slowly focused.

On the other hand, for example, it is assumed that the user fast performs the tracing process, and thus the “tracing time” is short. Further, it is assumed that the AF driving time set value (t) is set to a time T(F) shown in FIG. 14.

As apparent from the drawing, the “AF driving time set value (t)=T(L)” is shorter than the standard time T(M).

In this case, the driving speed of the focus lens 101 is set to the first driving speed V(F) shown in FIG. 14, and thus is set to be faster than the standard driving speed V(M).

That is, the focus lens is fast moved at the first driving speed V(F) to set the focused state from the focused state of a subject in the first AF frame 421 to the focused state of a subject in the second AF frame 422. As a consequence, the transition time from the focused state of the subject in the first AF frame 421 to the focused state of the subject in the second AF frame 422 is T(F), and thus the subject in the AF region corresponding to the second AF frame 422 is fast focused.

In step S404, the AF driving time set value (t) is determined based on the “tracing time” stored in the storage unit (for example, the memory (RAM) 121), and the driving speed (v) is calculated from the AF driving time set value (t) and the driving amount (d) calculated by the AF control unit 112a.

Next, in step S405, the focus lens 101 is driven in the driving direction calculated by the AF control unit 112a and the determined driving speed. That is, the focus lens 101 is moved so that the subject in the AF region selected by the user is focused.

In Embodiment 1, the AF control unit 112a controls the AF control time in accordance with the AF driving time set value (t) set in accordance with the “tracing time” of the user. Specifically, for example, in the setting of FIGS. 10A and 10B, the transition time from the focused state of the subject in the first AF frame 421 to the focused state, of the subject in the second AF frame 422 is controlled to be lengthened or shortened in accordance with the AF driving time set value (t) set based on the “tracing time” of the user. For example, the process makes it possible to achieve the image effect in which the process of changing the focus from the subject A to the subject B is performed slowly or rapidly, for example, when the moving image is reproduced.

### 4-2. Embodiment 2

### AF Control of Controlling Driving Speed of Focus Lens in Accordance with Touch Time of User's Finger on AF Region to be Newly Focused

Next, a process of selecting an AF region by continuously pressing the AF region as a new focusing target on the touch panel and setting an AF driving time will be described according to Embodiment 2.

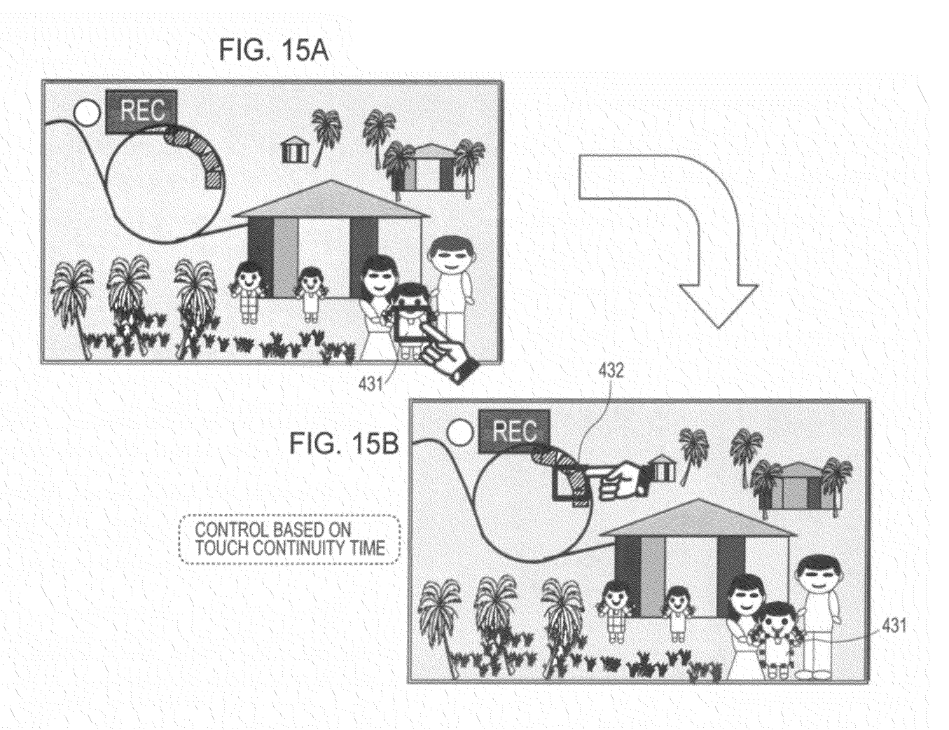

In the AF control according to this embodiment, the user continuously touches a second AF region corresponding to a second AF frame which is a new focus position, when the user changes the AF control position (focus position) from the first AF frame 421 of the first AF region to the second AF frame 422 of the second AF region, for example, as shown in FIGS. 15A and 15B.

The AF control unit measures the touch continuity time of the second AF region and controls the AF control time in accordance with the measurement time. That is, the AF control unit performs control of lengthening or shortening the transition time from the focused state of the subject in the first AF frame 421 to the focused state of the subject in the second AF frame 422. For example, the process makes it possible to achieve the image effect in which the process of changing the focus from the subject A to the subject B is performed slowly or rapidly, for example, when the moving image is reproduced.

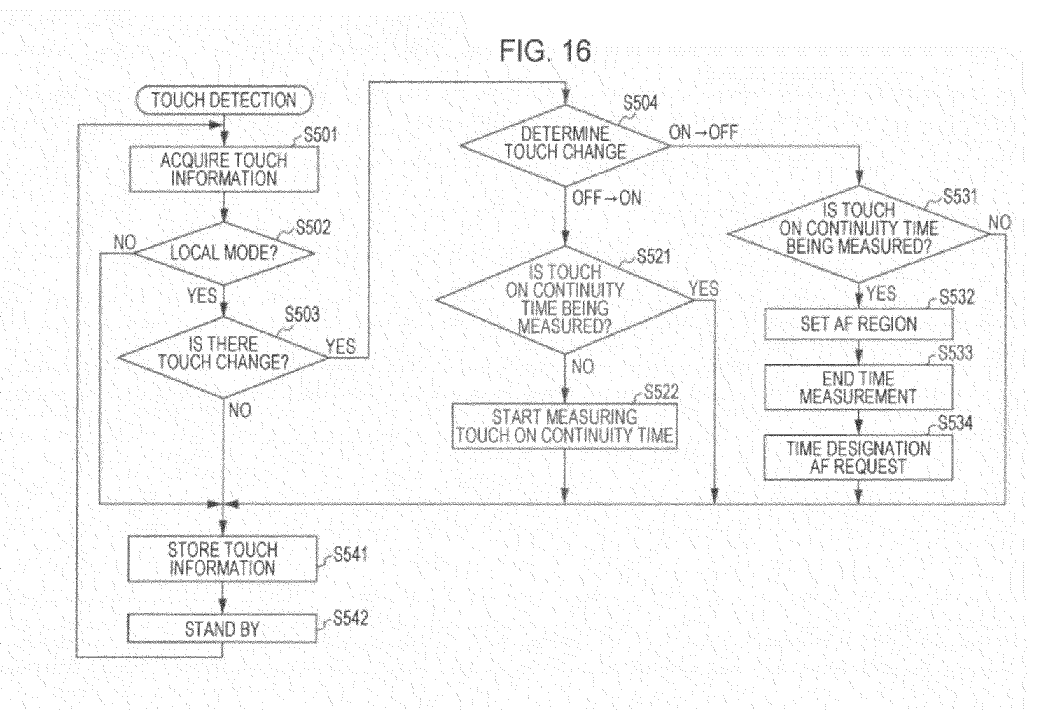

The sequence of the focus control process will be described with reference to the flowchart of FIG. 16.

In step S501, the AF control unit 112a acquires information regarding the touch of the user touching the touch panel (the monitor 117) of the operation unit 118.

As described above, the information regarding the touch includes (1) the touch state (touch ON/touch OFF) and (2) the touch position information of the user's finger or the like.

Next, in step S502, the setting mode of the focus area mode is confirmed. That is, it is confirmed whether the focus area mode is set to one of (1) the local mode, (2) the middle fixed mode, and (3) the wide mode.

When the focus area mode is set to the local mode, the process proceeds to step S503.

On the other hand, when the focus area mode is not set to the local mode, the process proceeds to step S541 and the information regarding the touch is stored in the memory unit (for example, the memory (RAM) 121).

When it is confirmed that the local mode is set in step S502, the process proceeds to step S503 to determine the touch state (ON/OFF) and the touch position on the touch panel.

In the local mode, as described above, the auto-focus is performed at one AF region selected by the photographer. That is, the auto focus is performed by setting the subject, which is contained in one AF region 151x selected from the plurality of regions 151a to 151z shown in FIG. 4 by the photographer, as the focusing target, that is, the focus operation target.

In step S503, when the latest touch state or touch position on the touch panel is not substantially identical with the previous touch state (ON/OFF) or the previous touch position stored in the storage unit (for example, the memory (RAM) 121), the process proceeds to step S504.

On the other hand, when both the latest touch state and touch position on the touch panel are identical with the previous touch state and previous touch position, the process proceeds to step S541 and the information regarding the touch is stored in the storage unit (for example, the memory (RAM) 121).

When it is determined that the latest touch state or touch position on the touch panel is not identical with at least one of the previous touch states or the previous touch positions stored in the storage unit (for example, the memory (RAM) 121) in step S503, the touch state change and the touch position change are determined in step S504.

When the previous touch state is determined to the touch OFF and the latest touch state is determined to the touch ON in step S504, the process proceeds to step S521.

When the previous touch state is determined to the touch ON and the latest touch state is determined to the touch OFF in step S504, the process proceeds to step S531.

When the previous touch state is determined to the touch OFF and the latest touch state is determined to the touch ON in the determination process of step S504, it is determined whether the “touch ON continuity time” is being measured in step S511.

The “touch ON continuity time” refers to a touch continuity time of the user's finger touching, for example, the AF frame 422 shown in FIGS. 10A and 10B.

When it is determined that the “touch ON continuity time” is not being measured, the process proceeds to step S522 to start measuring the “touch ON continuity time.”

On the other hand, when it is determined that the “touch ON continuity time” is being measured, the process proceeds to step S541 to store the information regarding the touch in the storage unit (for example, the memory (RAM) 121).

On other hand, when the previous touch state is determined to the touch ON and the latest touch state is determined to the touch OFF in the determination process of step S504, it is determined whether the “touch ON continuity time” is being measured in step S531.

When it is determined that the “touch ON continuity time” is being measured, the process proceeds to step S532. On the other hand, when it is determined that the “touch ON continuity time” is not being measured, the process proceeds to step S541 to store the information regarding the touch in the storage unit (for example, the memory (RAM) 121).

When it is determined that the “touch ON continuity time” is being measured in step S531 and the process proceeds to step S532, the AF region corresponding to the latest touch position is detected. That is, the “second local AF region identifier” which is the identifier of an AF region distant from the user's finger is acquired and stored in the storage unit (for example, the memory (RAM) 121).

In step S533, the measurement of the “touch ON continuity time” ends. When the measured “touch ON continuity time” is stored as an “AF driving time set value” in the storage unit (for example, the memory (RAM) 121).

The “second local AF region identifier” refers to the identifier of an AF region at a position where the user's finger is distant from the touch panel and an AF region where a subject which is the subsequent focusing target is contained. For example, in the example of FIGS. 15A and 15B, the AF frame 432 corresponds to the set AF region.

In step S534, the AF control unit 112a sets a “time designation AF operation request.”

The “time designation AF operation request” refers to a request for performing a process of applying the measured “touch ON continuity time”, adjusting the focus control time, and performing an AF operation. Further, information indicating whether the request is made may be stored as bit values in the memory (RAM) 121 such that [1]=request and [0]=no request.

When the “time designation AF operation request” is made, the focus control is performed by reflecting the “touch ON continuity time.” The sequence of this process is the process performed in accordance with the time designation AF process described above with reference to FIG. 13.

That is, in the process described above with reference to FIG. 13, the “tracing time” is substituted by the “touch ON continuity time.”

Step S541 is a step in which the touch state and the touch position are stored as the previous touch state and the previous touch position in the storage unit in the storage unit (for example, the memory (RAM) 121).

Step S542 is a step in which the AF control unit 112a stands by during a predetermined standby time (for example, 100 ms), since the touch panel process is performed at, for example, an 100 ms interval. After the standby, the process returns to step S501 and the same processes are repeated.

The AF process according to Embodiment 2 is the process performed in accordance with the flowchart of FIG. 12 described above in Embodiment 1.

As described above, in the AF process in which the “time designation AF operation request” is made, the “tracing time” is substituted by the “touch ON continuity time” in the process described above with reference to FIGS. 13 and 14.

That is, in Embodiment 2, the AF driving time set value (t) corresponds to the “touch ON continuity time” set by the user. The “touch ON continuity time” may satisfy an equation below:

AF driving time set value (t)=“touch ON continuity time.”

Further, the AF driving time set value (t) may be set by corresponding to “touch ON continuity time” ranges partitioned by predetermined threshold values as follows:

AF driving time set value (t)=T1 when Tha≦“touch ON continuity time”<Thb;

AF driving time set value (t)=T2 when Thb≦“touch ON continuity time”<Thc; and

AF driving time set value (t)=T3 when Thc≦“touch ON continuity time”<Thd.

As examples of the above settings, for example, the following settings can be made:

AF driving time set value t=TL corresponding to slow focus control;

AF driving time set value t=TM corresponding to standard focus control; and

AF driving time set value t=TF corresponding to fast focus control.

As described above, a relation equation between the driving time (t), the driving speed (v), and the driving amount (d) is as follows;

d=((v/A)×2×v÷2)+(t−(v/A)×2)×v.

An example of a specific focus control process will be described with reference to FIG. 14.

The standard time of the AF driving time set value (t) is assumed to be a standard time T(M). The driving speed of the focus lens at the standard time T(M) is assumed to be a standard driving speed V(M).

In the settings, the AF control unit 112a determines the AF driving time set value (t) based on the “touch ON continuity time” of the user.

For example, it is assumed that the “touch ON continuity time” by the user is long and it is assumed that the AF driving time set value (t) is set to a time T(L) shown in FIG. 14.

As apparent from the drawing, the “AF driving time set value (t)=T(L)” is longer than the standard time T(M).

In this case, the driving speed of the focus lens 101 is set to the second driving speed V(L) shown in FIG. 14, and thus is set to be slower than the standard driving speed V(M).

That is, as shown in FIGS. 15A and 15B, the focus lens is slowly moved at the second driving speed V(L) to set the focused state from the focused state of a subject in a first AF frame 431 to the focused state of a subject in a second AF frame 432. As a consequence, the transition time from the focused state of the subject in the first AF frame 431 to the focused state of the subject in the second AF frame 432 is T(L), and thus the subject in the AF region corresponding to the second AF frame 432 is slowly focused.

On the other hand, for example, it is assumed that the user fast performs the tracing process, and thus the “touch ON continuity time” is short. Further, it is assumed that the AF driving time set value (t) is set to a time T(F) shown in FIG. 14.

As apparent from the drawing, the “AF driving time set value (t)=T(F)” is shorter than the standard time T(M).

In this case, the driving speed of the focus lens 101 is set to the first driving speed V(F) shown in FIG. 14, and thus is set to be faster than the standard driving speed V(M).

That is, the focus lens is fast moved at the first driving speed V(F) to set the focused state from the focused state of a subject in the first AF frame 421 to the focused state of a subject in the second AF frame 422. As a consequence, the transition time from the focused state of the subject in the first AF frame 421 to the focused state of the subject in the second AF frame 422 is T(F), and thus the subject in the AF region corresponding to the second AF frame 422 is fast focused.

In Embodiment 2, in step S404 of the flowchart of FIG. 13, the AF driving time set value (t) is determined based on the “touch ON continuity time” stored in the storage unit (for example, the memory (RAM) 121), and the driving speed (v) is calculated from the AF driving time set value (t) and the driving amount (d) calculated by the AF control unit 112a.

Next, in step S405, the focus lens 101 is driven in the driving direction calculated by the AF control unit 112a and the determined driving speed. That is, the focus lens 101 is moved so that the subject in the AF region selected by the user is focused.

In Embodiment 2, the AF control unit 112a controls the AF control time in accordance with the AF driving time set value (t) set in accordance with the “touch ON continuity time” of the user. Specifically, for example, in the setting of FIGS. 15A and 15B, the transition time from the focused state of the subject in the first AF frame 431 to the focused state of the subject in the second AF frame 432 is controlled to be lengthened or shortened in accordance with the AF driving time set value (t) set based on the “tracing time” of the user. For example, the process makes it possible to achieve the image effect in which the process of changing the focus from the subject A to the subject B is performed slowly or rapidly, for example, when the moving image is reproduced.

### 4-3. Embodiment 3

### AF Control of Controlling Driving Speed of Focus Lens in Accordance with Movement Amount (Distance) of User's Finger Between AF Regions

Next, a process of controlling the driving speed of the focus lens in accordance with a movement amount (distance) of the user's finger between the AF regions on the touch panel will be described according to Embodiment 3.

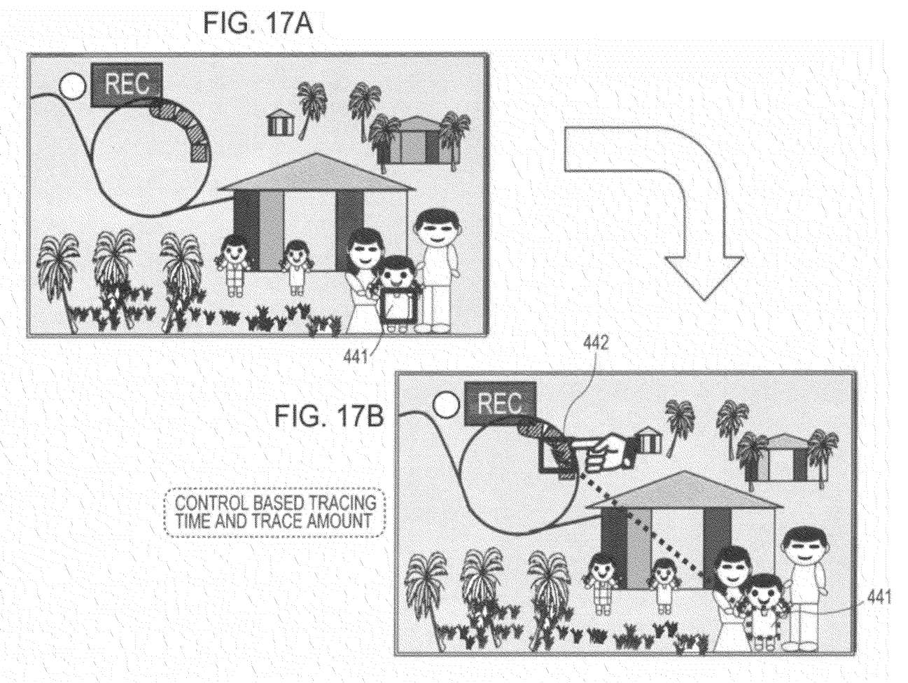

In an AF control process of Embodiment 3, for example, as shown in FIGS. 17A and 17B, as in Embodiment 1 described above, when the user changes the AF control position (focus position) from a first AF frame 441 of a first AF region to a second AF frame 442 of a second AF region, the user slides his or her finger to perform a “tracing process” of tracing the AF control position from the first AF frame 441 of the first AF region to the second AF frame 442 of the second AF region.

In Embodiment 3, a “tracing time” and a “tracing amount” are measured in the “tracing process.”

A “tracing amount” per unit time of the user is detected based on the “tracing time” and the “tracing amount.” A transition of “tracing speed change” of the user is calculated based on the “tracing amount” per the unit time.

In Embodiment 3, the AF control time is controlled based on the “tracing speed change.” That is, the movement speed of the focus lens is changed in multiple stages in accordance with the “tracing speed change” of the user in a transition process from the focused state of a subject in the first AF frame 441 to the focused state of a subject in the second AF frame 442, for example, as shown in FIGS. 17A and 17B. For example, the movement speed of the focus lens is changed sequentially in the order of a high speed, an intermediate speed, and a low speed.

This process makes it possible to achieve an image effect in which the process of changing the change speed of the focus from the subject A to the subject B in multiple stages, for example, a moving image is reproduced.

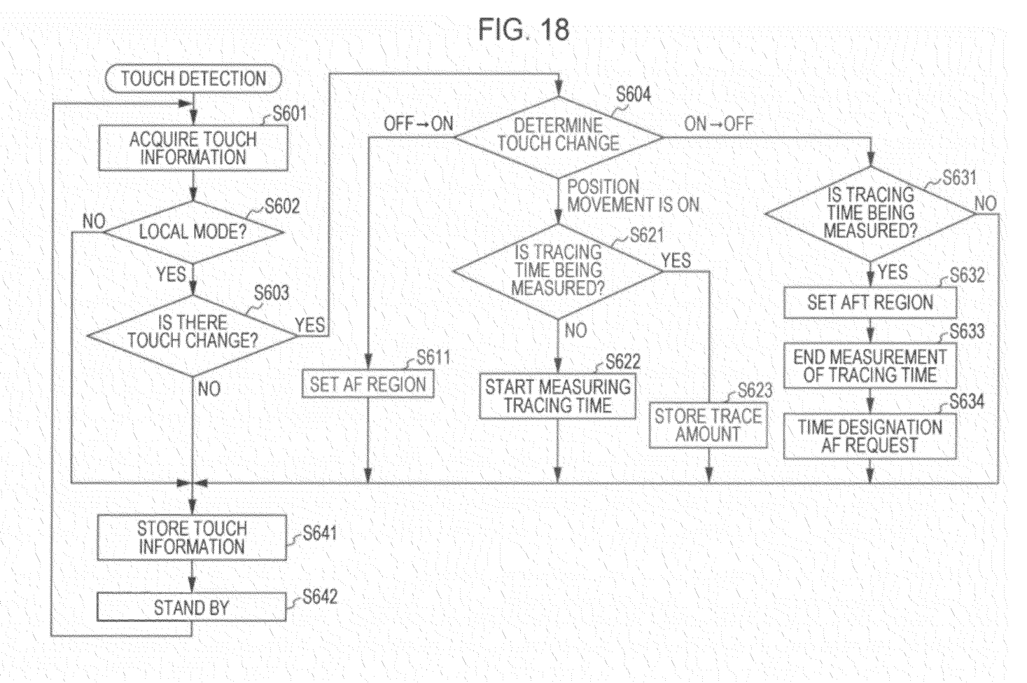

The sequence of the focus control process will be described with reference to the flowchart of FIG. 18.

In step S601, the AF control unit 112a acquires information regarding touch of the user touching the touch panel (the monitor 117) of the operation unit 118.

As described above, the information regarding the touch includes (1) the touch state (touch ON/touch OFF) and (2) the touch position information of the user's finger or the like.

Next, in step S602, the setting mode of the focus area mode is confirmed. That is, it is confirmed whether the focus area mode is set to one of (1) the local mode, (2) the middle fixed mode, and (3) the wide mode.

When the focus area mode is set to the local mode, the process proceeds to step S603.

On the other hand, when the focus area mode is not set to the local mode, the process proceeds to step S641 and the information regarding the touch is stored in the memory unit (for example, the memory (RAM) 121).

When it is confirmed that the local mode is set in step S602, the process proceeds to step S603 to determine the touch state (ON/OFF) of the touch position on the touch panel.

In the local mode, as described above, the auto-focus is performed at one AF region selected by the photographer. That is, the auto focus is performed by setting the subject, which is contained in one AF region 151x selected from the plurality of regions 151a to 151z shown in FIG. 4 by the photographer, as the focusing target, that is, the focus operation target.

In step S603, when the latest touch state or touch position on the touch panel is not substantially identical with the previous touch state (ON/OFF) or the previous touch position stored in the storage unit (for example, the memory (RAM) 121), the process proceeds to step S604.

On the other hand, when both the latest touch state and touch position on the touch panel are identical with the previous touch state and previous touch position, the process proceeds to step S641 and the information regarding the touch is stored in the storage unit (for example, the memory (RAM) 121).

When it is determined that the latest touch state or touch position on the touch panel is not identical with at least one of the previous touch states or the previous touch positions stored in the storage unit (for example, the memory (RAM) 121) in step S603, the touch state change and the touch position change are determined in step S604.

When the previous touch state is determined to the touch OFF and the latest touch state is determined to the touch ON in step S604, the process proceeds to step S611.

When the previous touch state is determined to the touch ON, the latest touch state is determined to the touch ON, and the latest touch position is not identical with the previous touch position in step S604, the process proceeds to step S621.

When the previous touch state is determined to the touch ON and the latest touch state is determined to the touch OFF in step S604, the process proceeds to step S631.

When the previous touch state is determined to the touch OFF and the latest touch state is determined to the touch ON in the determination process of step S604, the AF region corresponding to the latest touch position of the user is extracted and stored as a “first local AF region identifier in the storage unit (for example, the memory (RAM) 121) in step S611.

On the other hand, when the previous touch state is determined to the touch ON, the latest touch state is determined to the touch ON, and the latest touch position is not identical with the previous touch position in the determination process of step S604, it is determined whether a “tracing time” is being measured in step S621.

The “tracing time” refers to a movement time of the user's finger along a path from the AF frame 441 to the AF frame 442, for example, as shown in FIGS. 17A and 17B.

When it is determined that the “tracing time” is not being measured, the process proceeds to step S622 to measure the tracing time and the process proceeds to step S641 to store the information regarding the touch in the storage unit (for example, the memory (RAM) 121).

On the other hand, when it is determined that the “tracing time” is being measured, the process proceeds to step S623.

In step S623, the “tracing amount” is stored in the storage unit (for example, the memory (RAM) 121). For example, when it is assumed that coordinates (sX, sY) are the coordinates of the touch position at the previous measurement time and coordinates (dX, dY) are the coordinates of the current new touch position, a “tracing amount L” is calculated by an equation below.

L=\sqrt{(dX−sX)²+(dY−sY)²}

When the standby time of step S642 is equal to 100 msec, the “tracing amount L” is measured at an 100 ms interval.

The storage unit (for example, the memory (RAM) 121) sequentially stores the tracing amounts (for example, up to 100 amounts) and stores the “tracing amount L” at the 100 ms interval. Then, a total of the tracing amounts of 10 seconds (1000 ms) can be stored.

For example, the “tracing amounts” in a 100 ms unit are recorded in the storage as follows:

tracing time: 0 to 100 ms→tracing amount: 10 mm;

tracing time: 100 to 200 ms→tracing amount: 20 mm;

tracing time: 200 to 300 ms→tracing amount: 30 mm; and

tracing time: 300 to 400 ms→tracing amount: 20 mm.

When the “tracing amounts” are stored in step S623, the process proceeds to step S641 to store the information regarding the touch in the storage unit (for example, the memory (RAM) 121).

On the other hand, when the previous touch state is determined to the touch ON and the latest touch state is determined to the touch OFF in the determination process of step S604, it is determined whether the “tracing time” is being measured in step S631.

When it is determined that the “tracing time” is being measured, the process proceeds to step S632. On the other hand, when it is determined that the “tracing time” is not being measured, the process proceeds to step S641 to store the information regarding the touch in the storage unit (for example, the memory (RAM) 121).

When it is determined that the “tracing time” is being measured in step S631 and the process proceeds to step S632, the AF region corresponding to the latest touch position is detected. That is, the “second local AF region identifier” which is the identifier of an AF region distant from the user's finger is acquired and stored in the storage unit (for example, the memory (RAM) 121).

Then, the measurement of the “tracing time” ends in step S633. The measured “tracing time” is stored as an “AF driving time set value” in the storage unit (for example, the memory (RAM) 121).

Further, the “second local AF region identifier” refers to the identifier of an AF region where the user's finger is distant from the touch panel and is an AF region where a subject which is the subsequent focusing target is contained. For example, in the example of FIGS. 17A and 17B, the AF frame 422 corresponds to the set AF region.

In step S634, the AF control unit 112a sets a “time designation AF operation request.”

In this embodiment, the “time designation AF operation request” refers to a request for performing a process of applying the measured “tracing times” and the “tracing amounts”, adjusting the focus control time, and performing an AF operation. Further, information indicating whether the request is made may be stored as bit values in the memory (RAM) 121 such that [1]=request and [0]=no request.

When the “time designation AF operation request” is made, the focus control is performed by reflecting the “tracing times” and the “tracing amounts.”

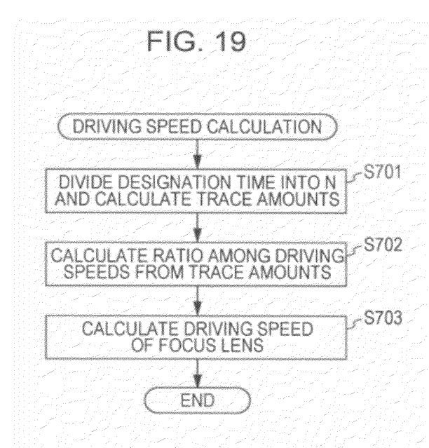

In the sequence of the process, the process of calculating the driving speed of the focus lens in step S404 in the process performed in accordance with the time designation AF process described above with reference to FIG. 13 is substituted by a process performed in the flowchart of FIG. 19 described below.

Step S641 is a step in which the touch state and the touch position are stored as the previous touch state and the previous touch position in the storage unit in the storage unit (for example, the memory (RAM) 121).

Step S642 is a step in which the AF control unit 112a stands by during a predetermined standby time (for example, 100 ms), since the touch panel process is performed at, for example, an 100 ms interval. After the standby, the process returns to step S601 and the same processes are repeated.

The AF process according to Embodiment 3 is the same as the process performed in accordance with the flowchart of FIG. 12 described above in Embodiment 1.

As described above, in the AF process in which the “time designation AF operation request” is made, the process of calculating the driving speed of the focus lens in step S404 in the process described above with reference to FIG. 13 is substituted by the process performed in the flowchart of FIG. 19 described below.

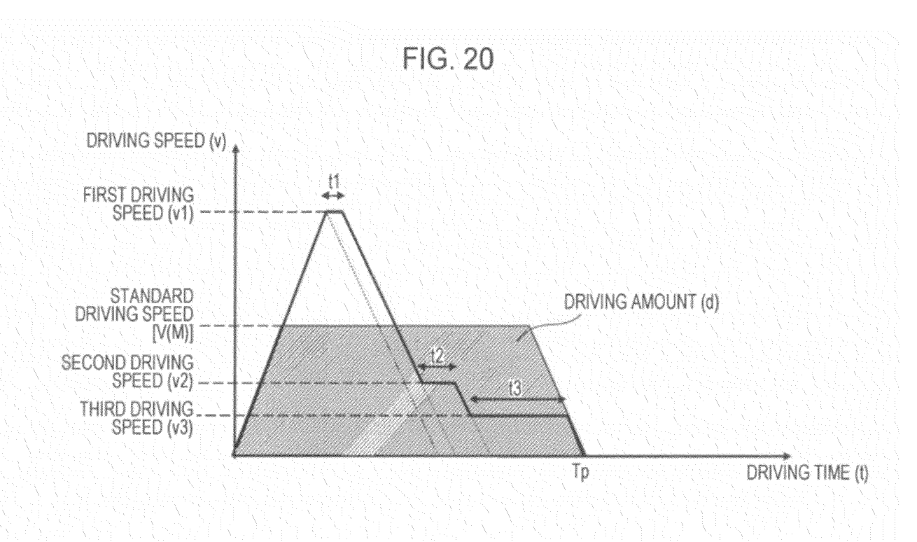

The process of calculating the driving speed of the focus lens in Embodiment 3 will be described with reference to the flowchart of FIG. 19 and FIG. 20.

The process of each step of the flowchart of FIG. 19 will be described.

In step S701, the AF control unit 112a divides the AF driving time set value into n times and calculates the sum of the tracing amounts of n time sections.

Here, n is any number equal to or greater than 2 is a preset value or a value set by the user.

For example, an example of “n=3” will be described.

For example, it is assumed that the AF driving time set value corresponding to the total “tracing time” is 2.4 seconds (2400 ms). That is, it is assumed that an AF driving time set value (Tp) corresponding to a “tracing time” from the first AF region where the first AF frame 441 is present to the second AF region where the second AF frame 442 is present, as in FIGS. 17A and 17B, is 2.4 seconds (2400 ms).

The AF control unit 112a divides the AF driving time set value Tp=2.4 seconds (2400 ms) into n times. When n is equal to 3 and the AF driving time set value is divided into three times, “2.4/3=0.8” seconds is obtained.

The AF control unit 112a calculates the sum of the tracing amounts of an interval of 0.8 seconds (800 ms). That is, three tracing amounts are calculated based on the “tracing amounts” stored in the storage unit as follows:

a first tracing amount between the start of the tracing process and 0 to 0.8 seconds;

a second tracing amount between the start of the tracing process and 0.8 to 1.6 seconds; and

a third tracing amount between the start of the tracing process and 1.6 to 2.4 seconds.

For example, it is assumed that the tracing amounts of the respective time sections are as follows:

(1) the first tracing amount between the start of the tracing process and 0 to 0.8 seconds (first time section)=300;

(2) the second tracing amount between the start of the tracing process and 0.8 to 1.6 seconds (second time section)=100; and

(3) the third tracing amount between the start of the tracing process and 1.6 to 2.4 seconds (third time section)=50. The unit of the tracing amount may be set as various units such as mm or the number of pixels.

In step S702, the AF control unit 112a calculates a ratio among the driving speeds of the focus lens from the tracing amounts of the respective time sections. The driving speeds of the focus lens are assumed as follows:

(1) v1 is the driving speed of the focus lens between the start of the tracing process and 0 to 0.8 seconds (first time section);

(2) v2 is the driving speed of the focus lens between the start of the tracing process and 0.8 to 1.6 seconds (second time section); and

(3) v3 is the driving speed of the focus lens between the start of the tracing process and 1.6 to 2.4 seconds (third time section).

When it is assumed that v1, v2, and v3 are the driving speeds of the respective time sections, the ratio among the driving speeds is set as the same ratio as the ratio among the tracing amounts of the respective time sections.

That is, a ratio of “v1:v2:v3=300:100:50=6:2:1” is obtained.

In order to equally divide the n time sections obtained through the dividing with respect to the movement distance of the focus lens, driving times, t1, t2, and t3 of the respective time sections (first to third time sections) excluding an addition-subtraction speed period are set to reciprocals of the driving speeds v1, v2, and v3 as follows:

t1:t2:t3=(1/6):(1/2):(1/1)=1:3:6.

In step S703, the AF control unit 112a drives the focus lens based on the driving speed and the driving time of the focus lens determined through the above-described processes.

The process of driving the focus lens based on the above-described setting is shown in FIG. 20.

When it is assumed that the addition-subtraction speed for driving the focus is a fixed value A, a relation equation between the driving time (Tp), the driving speed (v1), the driving speed (v2), the driving speed (v3), and the driving amount (d) is as follows:

d=(v1÷A×2×v1÷2)+(Tp−v1÷A×2)×(1/10)×v1+(Tp−v1÷A×2)×(3/10)×v2+(Tp−v1÷A×2)×(6/10)×v3

In this way, the AF control of changing the driving speed of the focus lens is performed in accordance with the change in the tracing speed by the tracing of the user's finger. That is, the focusing can be performed by driving the focus initially and slowing the speed gradually.

According to Embodiment 3, the AF control unit 112a changes the driving speed of the focus lens in accordance with the “change in the tracing speed” calculated based on the “tracing time” and the “tracing amount” of the user. Specifically, for example, in the setting of FIGS. 17A and 17B, the driving speed of the focus lens is changed in accordance with the change in the tracing speed of the user in the transition process from the focused state of the subject in the first AF frame 441 to the focused state of the subject in the second AF frame 442. This process makes it possible to achieve a moving-image reproduction effect of the focusing operation of obtaining various changes by performing the process of changing the focus from the subject A to the subject B, for example, from a low speed to a high speed or from a high speed to a low speed, for example, when a moving image is reproduced.

The embodiments of the present disclosure have hitherto been described in detail. However, it is apparent to those skilled in the art that the embodiments are modified and substituted within the scope of the present disclosure without departing from the gist of the present disclosure. That is, since the embodiments of the present disclosure have been described as examples, the present disclosure should not be construed as being limited. The claims of the present disclosure have to be referred to determine the gist of the present disclosure.

The above-described series of processes of the specification can be executed by hardware, software, or a combination of both hardware and software. When the series of processes are executed by software, a program recording the processing sequence may be installed in a memory of a computer embedded in dedicated hardware or may be installed in a general computer capable of executing various kinds of processes. For example, the program may be recorded in advance in a recording medium. Not only the program may be installed to the computer, but also the program may be received via a network such as a LAN (Local Area Network) or the Internet and may be installed to a recording medium such as an internal hard disk.

The various processes described in the specification may be executed chronologically in accordance with the description and may be also executed in parallel or individually in accordance with the processing performance of an apparatus performing the processes or as necessary. In the specification, a system is a logical collection of a plurality of apparatuses and is not limited to a configuration where each apparatus is in the same casing.

The present disclosure contains subject matter related to that disclosed in Japanese Priority Patent Application JP 2011-035888 filed in the Japan Patent Office on Feb. 22, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
a display unit that displays an image photographed by an imaging element; and
a focus control unit that performs focus control of inputting information regarding a selected image region of the image displayed on the display unit and setting a subject contained in the selected image region as a focusing target,
wherein the focus control unit performs the focus control by determining a driving speed of a focus lens based on information regarding an operation of a user and moving the focus lens at the determined driving speed of the focus lens.

2. The imaging apparatus according to claim 1, wherein the focus control unit performs focus control of determining a driving time of the focus lens in accordance with a tracing time of the user from a focused first image region displayed on the display unit to a second image region, which is a subsequent focusing target, and setting the determined driving time of the focus lens as a movement time of the focus lens.

3. The imaging apparatus according to claim 2, wherein the focus control unit determines a driving speed of the focus lens so as to complete a focusing process on a subject of the second image region at the determined driving time of the focus lens and moves the focus lens at the determined driving speed of the focus lens.

4. The imaging apparatus according to claim 1, wherein the focus control unit performs focus control of determining a driving time of the focus lens in accordance with a touch continuity time of the user touching an image region, which is a subsequent focusing target, displayed on the display unit and setting the determined driving time of the focus lens as a movement time of the focus lens.

5. The imaging apparatus according to claim 4, wherein the focus control unit determines a driving speed of the focus lens so as to complete a focusing process on a subject of the image region, which is the subsequent focusing target, at the determined driving time of the focus lens and moves the focus lens at the determined driving speed of the focus lens.

6. The imaging apparatus according to claim 1, wherein the focus control unit performs focus control of determining a driving time and a driving speed of the focus lens in accordance with a tracing time of the user tracing a focused first image region displayed on the display unit to a second image region, which is a subsequent focusing target, and a tracing amount per unit time and moving the focus lens in accordance with the determined driving time and driving speed of the focus lens.

7. The imaging apparatus according to claim 6, wherein the focus control unit performs focus control of moving the focus lens at the determined driving time and driving speed of the focus lens so as to complete a focusing process on a subject of the second image region.

8. The imaging apparatus according to claim 6, wherein the focus control unit performs focus control of dividing a total time of the tracing time of the user tracing the focused first image region displayed on the display unit to the second image region, which is the subsequent focusing target into a plurality of times, determining a driving speed of the focus lens in a divided time unit in accordance with a tracing amount of the divided time unit, and moving the focus lens in accordance with the determined driving speed of the locus lens in the divided time unit.

9. The imaging apparatus according to claim 1,
wherein the imaging element performs the focus control in accordance with a phase difference detecting method and includes a plurality of AF regions having a phase difference detecting pixel performing focus control in accordance with a phase difference detecting method, and
wherein the focus control unit selects an AF region corresponding to a touch region of the user on the display unit as an AF region which is a focusing target.

10. A focus control method performed in an imaging apparatus, comprising:
performing, by a focus control unit, focus control of inputting information regarding a selected image region of an image displayed on a display unit and setting a subject contained in the selected image region as a focusing target,
wherein the focus control is focus control of determining a driving speed of a focus lens based on information regarding an operation of a user and moving the focus lens at the determined driving speed of the focus lens.

11. A program performing focus control in an imaging apparatus, causing a focus control unit to perform the focus control of inputting information regarding a selected image region of an image displayed on a display unit and setting a subject contained in the selected image region as a focusing target.
wherein in the focus control, the focus control unit performs the focus control by determining a driving speed of a focus lens based on information regarding an operation of a user and moving the focus lens at the determined driving speed of the focus lens.
